(19) United States
(12) Patent Application Publication
(10) Pub. No.: US 2026/0121439 A1
(43) Pub. Date: Apr. 30, 2026

(54) Current Control Methodologies for Energy Storage Devices

(71) Applicant: instagrid GmbH, Ludwigsburg (DE)

(72) Inventor: Philipp Gutknecht, Stuttgart (DE)

(21) Appl. No.: 19/470,086

(22) PCT Filed: Mar. 28, 2025
(86) PCT No.: PCT/EP2025/058603

§ 371 Date: Sep. 29, 2025

(30) Foreign Application Priority Data
Apr. 24, 2024 (EP) 24172201.6

(51) Int. Cl. H02J 7/90; H02M 1/00; H02M 7/5395

(52) U.S. Cl. CPC H02J 7/933; H02M 1/0025; H02M 7/5395; H02J 2207/20; H02M 1/007

(57) ABSTRACT

Systems, methods and software products for operating circuit with energy storage module (ESM). The methods comprising: providing, at input port, an input voltage (IV); providing, via PWM, counter voltage (CV2); converting, via inductor, a difference between IV and CV2 to module current (MC) which charges or discharges ESM; providing reference waveform signal (RWS); generating error signal (ES) by combining MC measurement with RWS; applying, to ES, a transfer function (TF) to obtain correction signal (CS1); generating control signal (CS2) by combining CS1 with IV measurement; and using CS2 to govern MC's instantaneous value. TF may comprise: first gain component (FGC) having a higher than first-order low-pass response with a first corner frequency (CF), and a first low-frequency (DC) gain value; a second gain component acting parallelly to FGC and having a second low-frequency (DC) gain value; and a unit gain response providing a gain between TF's input and output.

### BACKGROUND

### Description of the Related Art

Battery cell packs are often used to power electronic devices. Different combinations of the battery cell packs are used to provide different output voltages.

### SUMMARY

The present disclosure concerns implementing systems and methods for operating a circuit with an energy storage module. The methods comprise: providing, at an input port, an input voltage; providing, via a pulse width modulator, a counter voltage; converting, via an inductor, a difference between the input voltage and the counter voltage to a module current which charges or discharges the energy storage module; providing a reference waveform signal; generating an error signal by combining a measurement of the module current with the reference waveform signal; applying, to the error signal, a transfer function to obtain a correction signal; generating a control signal by combining the correction signal with a measurement of the input voltage; and using the control signal to govern an instantaneous value of the module current to the energy storage module.

The transfer function comprises: a first gain component, wherein the first gain component has a higher than first-order low-pass response with a first low-frequency (DC) gain value; a second gain component acting parallelly to the first gain component, wherein the second gain component has a second low-frequency (DC) gain value; and a unit gain response providing a gain between an input and output of the transfer function. The first low-frequency (DC) gain value is higher than the second low-frequency (DC) gain value.

It shall be appreciated that the first gain component has a higher than first-order low-pass response, which means that the first gain component has a response which is of a higher order than a first-order low pass response. For example, the first gain component may have a low-pass response (e.g., gain-frequency response) that rolls off with a slope steeper than −20 decibels/decade (db/decade). For example, the first gain component may have a second-order low-pass response (e.g., two pole), or an even higher order response. It shall also be appreciated that for filters (e.g., low-pass filters), the terms “low-frequency gain” and “DC gain” can be used synonymously. These terms are generally used to specify gain which a low-pass filter has in the passband.

As shall be appreciated, the present teachings provide solutions which can ensure well-defined parameters (e.g., output voltage and/or current) of an electrical system despite internal and/or external non-idealities which can exist in practical systems. The present teachings can allow control of desired one or more parameters (e.g., voltage and/or current) whilst ensuring stable closed-loop response. The present teachings are especially useful for electrical systems comprising energy storage devices. Another highly relevant application of the present teachings is in buck-type power converters such as inverters. Especially in multi-level inverters (e.g., cascaded inverters), providing well defined output which is independent of non-idealities can be especially difficult. The present teachings can at least partially solve those problems.

### BRIEF DESCRIPTION OF THE DRAWINGS

The present solution will be described with reference to the following drawing figures, in which like numerals represent like items throughout the figures.

FIG. 1A provides a schematic diagram of an example energy storage module, according to some non-limiting embodiments or aspects.

FIG. 1B provides an illustrative block diagram of a circuit in the energy storage module.

FIG. 1C provides a circuit diagram of an energy storage module, according to some non-limiting embodiments or aspects.

FIG. 1D provides a perspective view of an energy storage module.

FIG. 1E provides an illustrative circuit diagram for the transistor active bridge circuit. FIGS. 1A-1E are collectively referred to as “FIG. 1”.

FIGS. 2A-2C (collectively referred to as “FIG. 2”) are schematic diagrams of an example energy storage module container of energy storage modules, according to some non-limiting embodiments or aspects.

FIGS. 3A and 3B (collectively referred to as “FIG. 3”) are schematic diagrams of an example power supply system, according to some non-limiting embodiments or aspects.

FIGS. 4A-4B each provide a circuit diagram of an example power supply system, according to some non-limiting embodiments or aspects.

FIG. 5 provides an illustration of a high-order voltage control loop.

FIG. 6 provides a graphs showing an illustrative frequency response of an anti-aliasing filter.

FIG. 7 provides a block diagram of an illustrative transfer function circuit for a gain element in a high-order voltage control loop.

FIG. 8 provides an illustrative response of digital domain parts of a high-order voltage control loop.

FIGS. 9A-9B (collectively referred to as “FIG. 9”) provide graphs that are useful for understanding operations of a high-order voltage control loop.

FIG. 10 provides a block diagram of another illustrative transfer function circuit for a gain element in a high-order voltage control loop.

FIG. 11 provides a graph showing the frequency response of the transfer function circuit shown in FIG. 10.

FIG. 12 provides a graph showing an open loop response of the transfer function circuit shown in FIG. 10.

FIG. 13 provides a block diagram for a current control loop.

FIG. 14 provides a graph showing a frequency response of an anti-aliasing filter.

FIG. 15 provides a graph showing an analog transfer function for an anti-aliasing filter combined with voltage difference to current translation in inductors.

FIGS. 16A-16B (collectively referred to as “FIG. 16”) each provides a block diagram of an illustrative transfer function circuit for a gain element in a current control loop.

FIG. 17 shows an illustrative response of digital domain parts of a current control loop.

FIGS. 18A-18B (collectively referred to as “FIG. 18”) provide graphs that are useful for understanding operations of a current control loop.

FIG. 19 provides a block diagram of an illustrative transfer function circuit for a gain element of a current control loop.

FIG. 20 provides a graph showing a frequency response of an anti-aliasing filter.

FIG. 21 provides a graph showing an open loop response graph for the transfer function circuit of FIG. 19.

FIG. 22 provides a block diagram of a high-order voltage control loop with a controlled voltage source model.

FIG. 23 provides a block diagram of a high-order voltage control loop with a unit delay.

FIGS. 24A-B (collectively referred to as “FIG. 24”) each provides a block diagram of another illustrative current control loop.

FIG. 25 shows waveforms at different points in a current control loop.

FIG. 26 provides a flow diagram of an illustrative method for operating a circuit.

FIGS. 27-29 each provides a flow diagram of an illustrative method of operating a circuit with an energy storage module.

FIG. 30 provides an illustration of a second order low pass filter.

### DETAILED DESCRIPTION

The present solution is described with reference to the attached figures. The figures are not drawn to scale and they are provided merely to illustrate the instant solution. Several aspects of the present solution are described below with reference to example applications for illustration. It should be understood that numerous specific details, relationships, and methods are set forth to provide a full understanding of the present solution. One having ordinary skill in the relevant art, however, will readily recognize that the present solution can be practiced without one or more of the specific details or with other methods. In other instances, well-known structures or operations are not shown in detail to avoid obscuring the present solution. The present solution is not limited by the illustrated ordering of acts or events, as some acts may occur in different orders and/or concurrently with other acts or events. Furthermore, not all illustrated acts or events are required to implement a methodology in accordance with the present solution.

It should also be appreciated that the terminology used herein is for the purpose of describing particular embodiments only and is not intended to be limiting of the present solution. As used herein, the singular forms “a”, “an” and “the” are intended to include the plural forms as well, unless the context clearly indicates otherwise. Furthermore, to the extent that the terms “including”, “includes”, “having”, “has”, “with”, or variants thereof are used in either the detailed description and/or the claims, such terms are intended to be inclusive in a manner similar to the term “comprising.”

Further, unless otherwise defined, all terms (including technical and scientific terms) used herein have the same meaning as commonly understood by one of ordinary skill in the art to which this solution belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

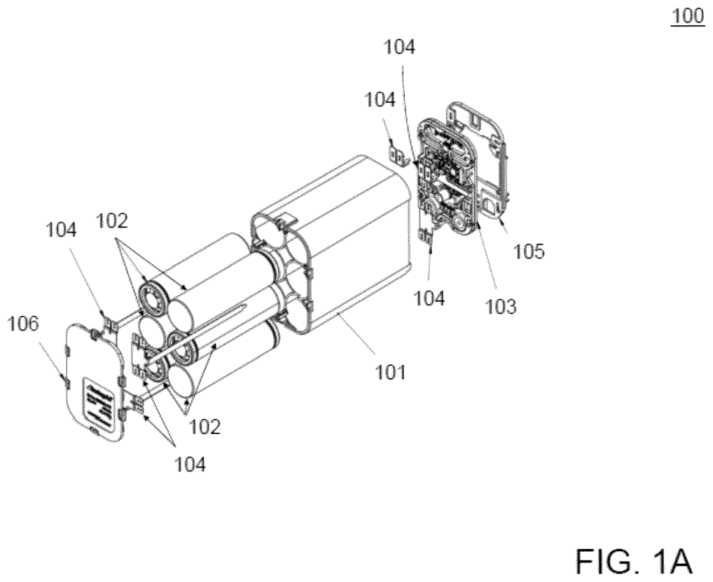

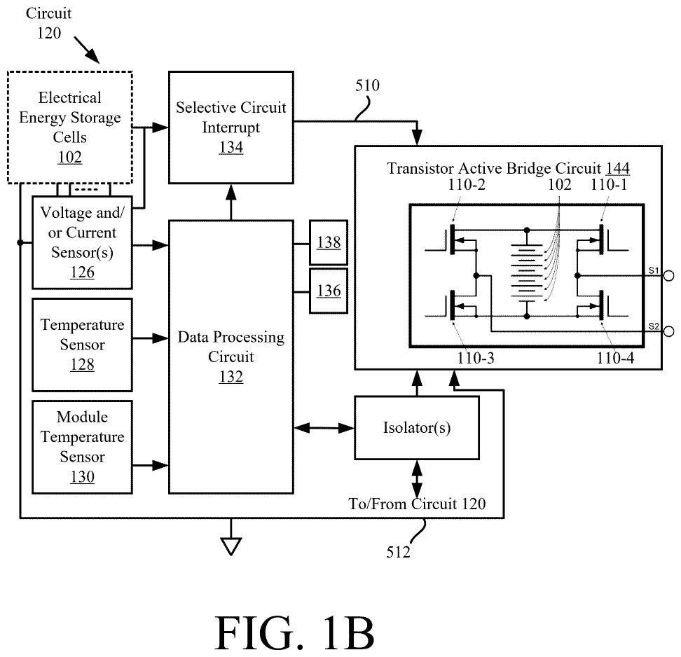

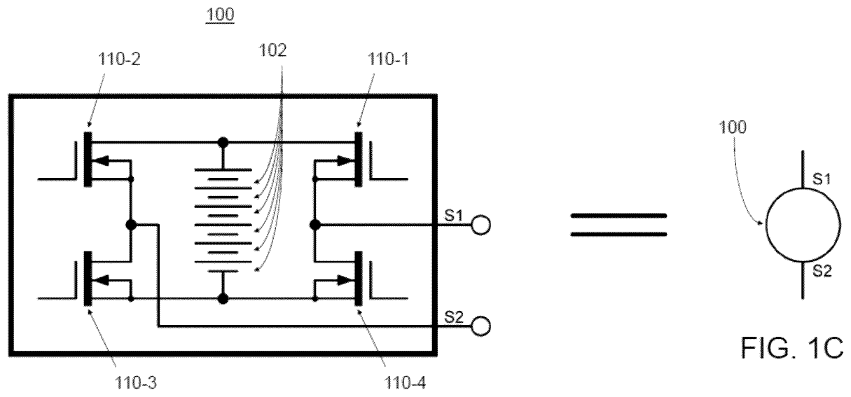

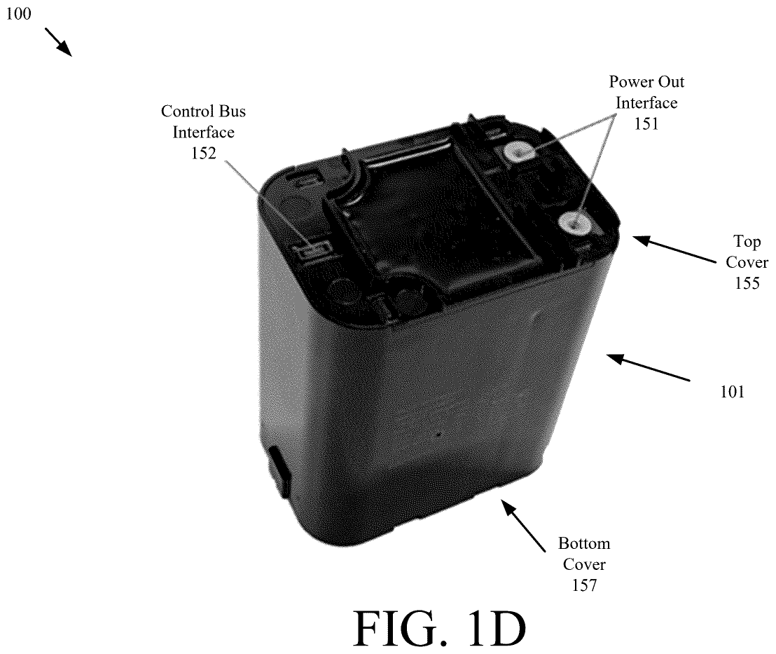

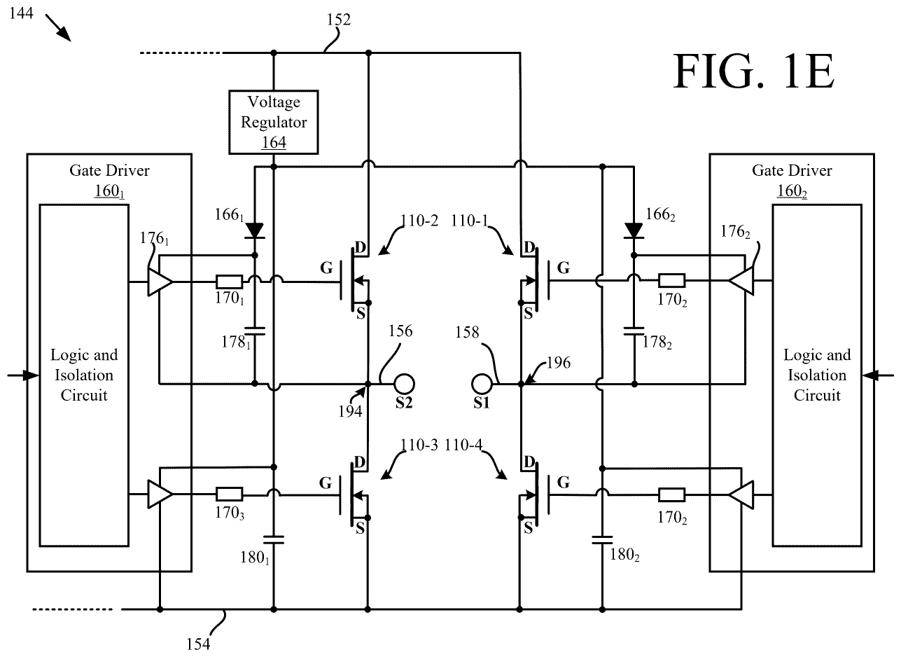

Referring now to FIG. 1A, depicted is a schematic diagram of an example energy storage module 100, according to some non-limiting embodiments or aspects. As shown in FIG. 1, energy storage module 100 may include housing 101, at least one energy storage component 102, module controller 103, connectors 104, top cover 105, and bottom cover 106. The number and arrangement of components shown are provided as an example. In some non-limiting embodiments or aspects, energy storage module 100 may include additional components, fewer components, different components, or differently arranged components than those shown. Additionally or alternatively, a set of components (e.g., one or more components) of energy storage module 100 may perform one or more functions described as being performed by another set of components of energy storage module 100.

In some non-limiting embodiments or aspects, housing 101 may include plastic, metal, any combination thereof, and/or the like. For example, housing 101 may include a plastic housing.

In some non-limiting embodiments or aspects, housing 101 may be configured to hold at least one (e.g., a plurality of) energy storage components 102. For example, as shown in FIG. 1, housing 101 may be shaped to have six energy storage components 102 uniformly distributed in an interior space defined by housing 101.

In some non-limiting embodiments or aspects, each energy storage component 102 may include at least one of a battery, a rechargeable battery (e.g., a lithium-ion battery), a cell (e.g., battery cell, an electrochemical cell, and/or the like), a rechargeable cell, a capacitor, an ultra-capacitor, any combination thereof, and/or the like. For example, as shown in FIG. 1, each energy storage component 102 may include a cylindrical cell (e.g., lithium-ion battery cell).

In some non-limiting embodiments or aspects, module controller 103 may include a controller and associated circuitry. Optionally, module controller 103 may include a microcontroller, a computing device, a processor, a microprocessor, a digital signal processor (DSP), and/or any processing component (e.g., a field-programmable gate array (FPGA), an application-specific integrated circuit (ASIC), etc.) that can be configured to perform at least one function.

In some non-limiting embodiments or aspects, connectors 104 may connect the terminals (e.g., ends) of each energy storage component 102 to module controller 103. Additionally or alternatively, at least one connector 104 may connect at least one terminal (e.g., end) of one energy storage component 102 to another terminal of another energy storage component 102. For example, connectors 104 may include a conductive (e.g., electrically conductive) material, such as metal and/or the like. In some non-limiting embodiments or aspects, some or all of the connectors 104 may be used for energy storage component 102 (e.g., cell) voltage measurements.

In some non-limiting embodiments or aspects, each of top cover 105 and bottom cover 106 may include plastic, metal, any combination thereof, and/or the like. For example, each of top cover 105 and bottom cover 106 may include a plastic cover. In some non-limiting embodiments or aspects, top cover 105 and bottom cover 106 may be configured to (e.g., sized and shaped to) cover openings at top and bottom ends, respectively, of housing 101. In some non-limiting embodiments or aspects, top cover 105 may include a first electrical connection (e.g., S1, as described herein), a second electrical connection (e.g., S2, as described herein), and/or at least one communication connection, as described herein. For example, these connections may allow for electrical and/or communicative connection between module controller 103 and external components (e.g., other components of the power supply system external to the energy storage module housing).

In some non-limiting embodiments or aspects, energy storage module 100 may include a battery module. For example, the battery module may include at least one energy storage component (e.g., a battery cell, such as a rechargeable battery cell). For the purpose of illustration, as shown in FIG. 1A, the battery module may include six energy storage components (e.g., rechargeable battery cells, such as lithium-ion cells, supercapacitors, and/or the like).

In some non-limiting embodiments or aspects, energy storage components 102 (e.g., battery cells) of energy storage module 100 may be connected in series. In some non-limiting embodiments or aspects, energy storage components 102 (e.g., battery cells) of energy storage module 100 may be connected in parallel.

In some non-limiting embodiments or aspects, at least some (e.g., a subset of) energy storage components 102 may be connected in series, for example, so that the combined (e.g., summed and/or the like) voltage of the series-connected components satisfies (e.g., equals, exceeds, and/or the like) the target (e.g., desired) operating voltage of energy storage module 100. In some non-limiting embodiments or aspects, at least some (e.g., a subset of) energy storage components 102 may be connected in parallel, for example, so that the combined (e.g., summed and/or the like) capacity (e.g., current) of the parallel-connected components satisfies (e.g., equals, exceeds, and/or the like) the target (e.g., desired) a target capacity (e.g., operating current of energy storage module 100). For example, energy storage module 100 may include a plurality of subsets of energy storage components 102 such that energy storage components 102 of each subset are connected in series (e.g., to combine to output the desired module voltage), and the subsets may be connected in parallel (e.g., to combine to output the desired module current).

In some non-limiting embodiments or aspects, energy storage module 100 may be the same as or similar to or include at least some components that are the same as or similar to the battery modules described in at least one of U.S. Patent Application Pub. No. 2022/0037891, U.S. Patent Application Pub. No. 2022/0247030, U.S. Patent Application Pub. No. 2022/0359918, and/or U.S. Patent Application Pub. No. 2022/0360094, the disclosures of each of which are hereby incorporated by reference in their entireties.

As shown in FIG. 1B, a circuit 120 of the energy storage module 100 comprises voltage and optionally, current sensors 126 connected to the energy storage components 102. These sensors 126 are configured to measure the voltage and/or current of each energy storage component. Circuit 120 also comprises temperature sensors 128 and a module temperature sensor 130 Each temperature sensor 128 is configured to measure a temperature of one or more energy storage components, while the module temperature sensor 130 is configured to measure an internal temperature of the energy storage module. These sensor measurements are communicated from the sensors 126, 128, 130 to the data processing circuit 132 for processing. The data processing circuit 132 can perform operations to communicate sensor measurements as sensor data to the module controller 103 or an external circuit, and/or perform operations to analyze the sensor measurements to determine if certain criteria is met. For example, if a parameter measurement falls outside of defined range at a given time or for a certain amount of time, then the data processing circuit 132 causes the selective circuit interrupt 134 to transition from a closed state to an open state such that the energy storage module 100 is turned off. The parameter measurement can include a voltage measurement, a current measurement or a temperature measurement.

The data processing circuit 132 may be configured to access datastore(s) 136. Datastore(s) 136 can comprise computer-readable storage medium on which is stored one or more sets of instructions configured to implement one or more of the methodologies, procedures, or functions described herein. The instructions can also reside, completely or at least partially, within the data processing circuit 132 during execution thereof by the data processing circuit 132. Datastore(s) 136 and data processing circuit 132 also can constitute machine-readable media. The term “machine-readable media”, as used here, refers to a single medium or multiple media (e.g., a centralized or distributed database, and/or associated caches and servers) that store the one or more sets of instructions. The term “machine-readable media”, as used here, also refers to any medium that is capable of storing, encoding or carrying a set of instructions for execution by the data processing circuit 132 and that cause the data processing circuit 132 to perform any one or more of the methodologies of the present disclosure. Data processing circuit 132 can include, but is not limited to, processor(s).

Circuit 120 also comprises a transistor active bridge circuit 144. The transistor active bridge circuit 144 comprises at least one switching element (e.g., first switching element 110-1, second switching element 110-2, third switching element 110-3, and/or fourth switching element 110-4, collectively referred to as “switching elements 110,” and individually referred to as “switching element 110”), first electrical connection S1, and second electrical connection S2.

In some non-limiting embodiments or aspects, switching elements 110 may be part of (e.g., integrated on, connected to, and/or the like) module controller 103. In some non-limiting embodiments or aspects, first electrical connection S1 and/or second electrical connection S2 may be part of (e.g., integrated on, connected to, and/or the like) module controller 103 and/or may extend through top cover 105. The number and arrangement of components shown are provided as an example. In some non-limiting embodiments or aspects, energy storage module 100 may include additional components, fewer components, different components, or differently arranged components than those shown. Additionally or alternatively, a set of components (e.g., one or more components) of energy storage module 100 may perform one or more functions described as being performed by another set of components of energy storage module 100.

As shown in the example in FIG. 1B, energy storage module 100 may include six energy storage components 102 (e.g., rechargeable battery cells and/or the like) connected in series. In some non-limiting embodiments or aspects, energy storage components 102 may be in other arrangements and/or have other connections, as described herein.

In some non-limiting embodiments or aspects, switching elements 110 may be switched (e.g., opened, closed, activated, deactivated, and/or the like) to selectively connect energy storage component(s) 102 to first electrical connection S1 and/or second electrical connection S2, e.g., to control a module voltage across first electrical connection S1 and second electrical connection S2. For example, switching elements 110 may be switched so that (1) first electrical connection S1 and second electrical connection S2 are both connected to negative side (e.g., DC minus) of energy storage component(s) 102, (2) first electrical connection S1 is connected to the negative side (e.g., DC minus) of energy storage component(s) 102 and second electrical connection S2 is connected to the positive side (e.g., DC plus) of energy storage component(s) 102, or (3) first electrical connection S1 is connected to the positive side (e.g., DC plus) of energy storage component(s) 102 and second electrical connection S2 is connected to the negative side (e.g., DC minus) of energy storage component(s) 102. As such, the voltage across first electrical connection S1 and second electrical connection S2 may be zero, negative, or positive, respectively.

For the purpose of illustration by way for a few examples, to connect both first electrical connection S1 and second electrical connection S2 to the negative side (e.g., DC minus) of energy storage component(s) 102, fourth switching element 110-4 and third switching element may both be activated (e.g., closed, set to act as a closed switch, and/or the like), while second switching element 110-2 and first switching element 110-1 are deactivated (e.g., open, set to act as an open switch, and/or the like). To connect first electrical connection S1 to the negative side (e.g., DC minus) and connect second electrical connection S2 to the positive side (e.g., DC plus) of energy storage component(s) 102, fourth switching element 110-4 and second switching element 110-2 may be activated, while third switching element 110-3 and first switching element 110-1 are deactivated. To connect first electrical connection S1 to the positive side (e.g., DC plus) and second electrical connection S2 to the negative side (e.g., DC minus) of energy storage component(s) 102, first switching element 110-1 and third switching element 110-3 may be activated, and fourth switching element 110-4 and second switching element 110-2 may be deactivated. In some non-limiting embodiments or aspects, the switching elements 110 may be operated to be in states such as: a high-impedance (Hi-Z) state (e.g., in which all of the switching elements 110 are deactivated), a bypass state (e.g., in which the low-side switching elements 110-3 and 110-4 are activated while the high-side switching elements 110-1 and 110-2 are deactivated), and two polarity states (e.g., in which the energy storage component(s) 102 are connected between the first electrical connection S1 and the second electrical connection S2 in opposite polarity manner).

In some non-limiting embodiments or aspects, each switching element 110 may include at least one of a transistor (e.g., bipolar transistor, field-effect transistor (FET), metal-oxide-semiconductor field-effect transistor (MOSFET), and/or the like), a switch, a contactor, any combination thereof, and/or the like. In some non-limiting embodiments or aspects, the energy storage module 100 may include one or more driver circuits, such as a gate driver circuit, for driving each switching element 110. For example, the driver circuits may be part of (e.g., integrated on, connected to, and/or the like) module controller 103.

In some non-limiting embodiments or aspects, each switching element 110 may be driven, or controlled, via the module controller 103. For example, module controller 103 may control the switching elements 110 to selectively connect energy storage component(s) 102 to first electrical connection S1 and/or second electrical connection S2, as described herein. For example, module controller 103 may be connected to each switching element 110 in order to drive, or optionally control, such switching element 110. In some non-limiting embodiments or aspects, the module controller 103 provides signals to the gate driver circuit for driving the switching elements 110.

As shown in FIG. 1C, each energy storage module 100 may be represented by the symbol shown in FIG. 1C (e.g., for brevity and clarity of the following drawings).

FIG. 1D provides an illustration of an energy storage module 100. An assembly view of the energy storage module 100 is provided in FIG. 1A. Energy storage module 100 comprises a housing 101 in which energy storage components 102 are housed so as to maintain certain positions relative to each other. The energy storage components 102 can be arranged in two rows of three energy storage components as shown in FIG. 1A. The present solution is not limited in this regard. The energy storage components can have a different arrangement than that shown in FIG. 1A. Any number of energy storage components can be provided in the energy storage module in accordance with a given application. Each energy storage component may include, but is not limited to, a lithium-ion cell. The lithium-ion cell may have a cylindrical shape as shown or another shape (e.g., a rectangular shape) not shown.

A top cover 155 and a bottom cover 157 are provided for the housing 101. The covers 155, 157 may be configured to provide an environment seal with the housing 101. The environmental seal may be facilitated by gaskets (not visible or shown in FIG. 1D and/or FIG. 1A) compressed between the covers 155, 157 and the housing's sidewalls.

The safe and reliable operation of the energy storage module 100 requires the constant monitoring of each energy storage component 102, e.g., to detect when its current (optional), voltage and/or temperature fall outside of defined operating range(s). This monitoring is achieved using a circuit 120 that is also housed in the housing 101. Conductive terminals 104 are provided to connect the energy storage components 102 to the circuit 120 for at least voltage measurements.

As shown in FIG. 1E, the transistor active bridge circuit 144 comprises gate drivers 160₁, 160₂, a voltage regulator 164, diodes 166₁, 166₂ (collectively referred to as “166”), optional resistors 170₁, 170₂, 170₃, 170₄ (collectively referred to as “170”), capacitors 178₁, 178₂, 180₁, 180₂, and a transistor active bridge 144. The transistor active bridge circuit 144 is supplied a voltage waveform from the energy storage components 102. As such, the transistor active bridge circuit 144 is connected to energy storage components 102 via input lines 152, 154. Input line 152 may be referred to as a high input line, while input line may be referred to as a low input line 154. The transistor active bridge circuit 144 is also connected between a pair of output lines 156, 158. The output lines 156, 158 are connected to the power interface 151 of FIG. 1D.

The transistor active bridge circuit 144 includes a plurality of switches, shown in this example as field-effect transistors (FETs) 110-2, 110-3, 110-1, 110-4 of an N-channel type. Each of the FETs may comprise a metal-oxide semiconductor FET (MOSFET), but other types of switches or FETs (e.g., insulated gate bipolar transistors (IGBTs), bipolar junction transistors (BJTs), gate turn-off thyristors (GTOs) or their likes or combinations) instead of the shown type can also be contemplated. Each FET 110-2, 110-3, 110-1, 110-4 has three (3) terminals respectively defined as a source S, a gate G and a drain D. An electrical path is be provided from the source to the drain of each FET 110-2, 110-3, 110-1, 110-4. This path is generally referred to herein as the source-drain path. A source-drain path of first FET 110-2 is connected in series with a source-drain path of the second FET 110-3. The series connected transistor pair 110-2, 110-3 form a first series transistor combination that is connected across the input lines 152, 154. A source-drain path of the third FET 110-1 is connected in series with a source-drain path of the fourth FET 110-4 to form a second series transistor combination connected across the input lines 152, 154.

The transistor active bridge circuit 144 can have an output defined by output lines 156, 158. A first one of the output lines 156 can be connected to the first series combination 110-2/110-3 at an interconnection point 194 between the first and the second field-effect transistors 110-2, 110-3. A second one of the output lines 158 can be connected to the second series combination 110-1/110-4 at an interconnection point 196 between the third and fourth field-effect transistors 110-1, 110-4.

Gate driver 160₁ is provided for driving the gate G of each FET 110-2, 110-3. Similarly, gate driver 160₂ is provided for driving the gate G of each FET 110-1, 110-4. In this regard, the gate drivers are configured to supply a voltage to the gate G of each respective FET at certain times for switching the FET to its “on” state or “off” state. The gate drivers are also configured to stop supplying the voltage to the gate G of the FET at certain times for switching the FET to its “on” state or “off” state. Gate driver circuits are well known. Known or to be known gate driver circuit can be used here.

When the gate drivers communicate gate control signals to the FETs, the FETs 110-2, 110-3, 110-1, 110-4 will be biased and switch to their “on” states. In effect, current will flow between the drain D and source S of these FETs. The FETs transition back to their “off” states when the gate control signals are no longer being output from the gate drivers. The gate drivers are configured to prevent the two FETs in each series pair 110-2/110-3 and 110-1/110-4 from being closed simultaneously or concurrently.

The FETs are switched alternatively by the gate driver to provide a certain power output across lines 156, 158. For example, when the energy storage module is in its “on” state, one of the high side FETs 110-2, 110-1 is transitioned to its “on” state for a given period of time (e.g., 1 microsecond (μs)-15 milliseconds (ms), as some further non-limiting examples, a few microseconds (μs), 10 μs, 20 μs, 50 μs, 0.1 ms, 2 ms, 5 ms, or even 10 ms). When the energy storage module is in its “off” state, the two high side FETs 110-2, 110-1 are in their “off” states and the two low side FETs 110-3, 110-4 are in their “on” states. In effect, the two low side FETs are conducting while the two high side FETs are not conducting.

The capacitors 178 are provided to store charge for driving the respective FETs 110-2, 110-4. The respective capacitor 178 is chargeable via their respective diode 166. In this regard, the supply voltage for the high-side gate driver output stages 1761, 1762 is stored in capacitors 178₁, 178₂. Each of the capacitors 178₁, 178₂ is recharged when the corresponding output line 156, 158 is slewing towards the low supply line 154, e.g., when the corresponding low side FETs 110-3 or 110-4 is switched to the “on” state. For example, when FET 110-3 is turned “on”, the potential at output S2 is pulled towards the potential at source S of FET 110-3. At this time, diode 166₁ becomes conductive such that current flows from the voltage regulator 164 through capacitor 178₁ and transistor 110-3 to line 154. In effect, capacitor 178₁ is recharged as the current flows therethrough. When the potential at output S2 is slewing towards the high supply line 152, the diode 166₁ acts as a blocking diode such that charge on the capacitor 178₁ is prevented from flowing back towards the voltage regulator 164. Thus, charged capacitor 178₁ supplies voltage is supplied from the capacitor 178₁ to the high-side gate driver output stage 1761 for driving the gate terminal of FET 110-2. At some point, the capacitor will be discharged to a level which may cause the gate driver 160₁ to enter an undervoltage mode in which the gate driver is not operational anymore. The capacitor is recharged before it reaches this level of discharge. An advantage of the preset teachings is that switching of the low-side FETs 110-3, 110-4 can be used to simultaneously charge their corresponding capacitor 178 which is used for driving the high-side FETs 110-2, 110-1.

It is rather common in gate driver circuits to use charge pumps or transformer isolated (e.g., multi-channel) DC-DC converters to facilitate power supply to the gate driver(s). These circuits tend to be relatively expensive. As evident from FIG. 1E, circuit 144 is absent of any charge pumps and therefore is less costly than conventional transistor active bridge circuits. The elimination of the charge pumps was achieved using circuit components 166, 178 to provide the voltage for the high-side gate driver output stages 176 in a controlled manner to avoid or minimize the likelihood that the gate driver 160₁ enters an undervoltage mode.

Capacitors 180₁, 180₂ has a similar role as capacitors 178₁, 178₂. However, capacitors 180₁, 180₂ are permanently supplied a voltage signal by the voltage regulator 164. As such, the low-side FETs 110-3, 110-4 can be turned “on” for as long as desired. When low-side FET 110-3 is in its “on” state, the potential at output S2 is equal to the potential at source S of FET 110-3. Likewise, the potential at output S1 is equal to the potentiation at source S of FET 110-4 when the FET is in its “on” state.

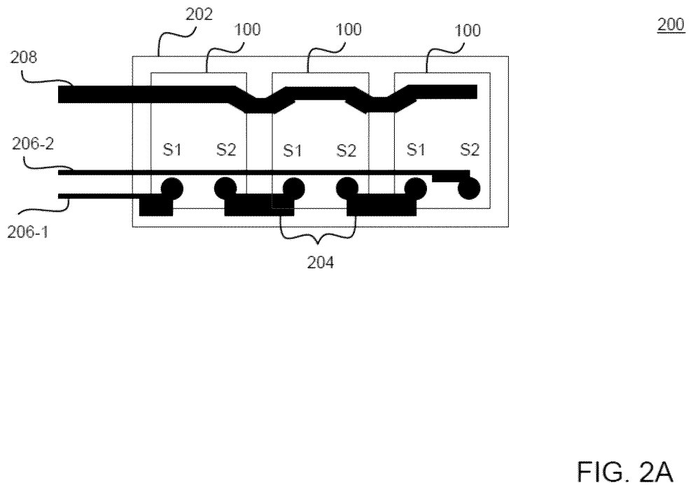

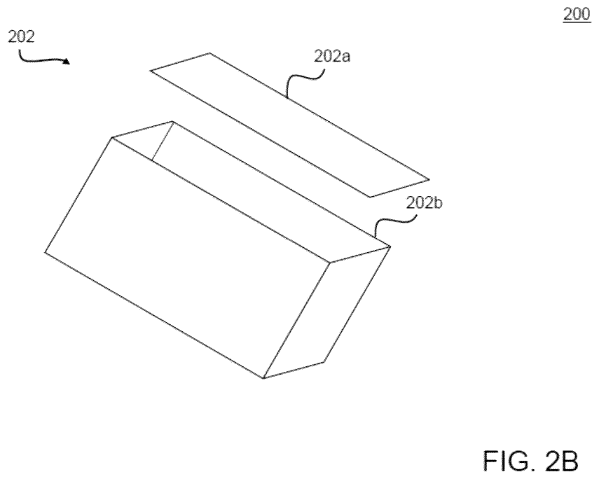

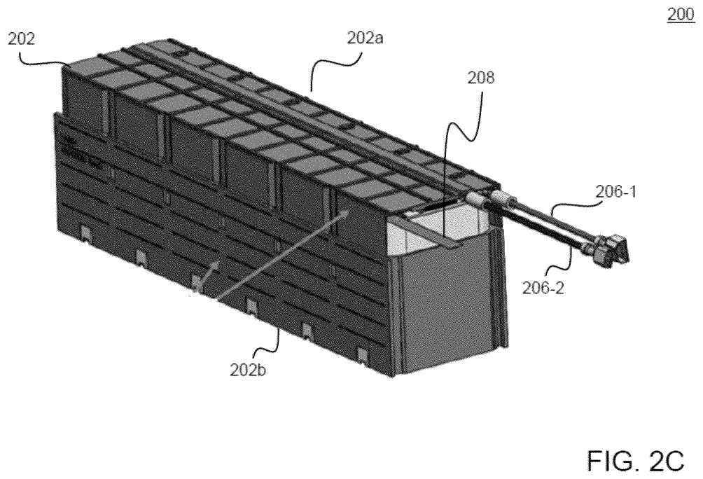

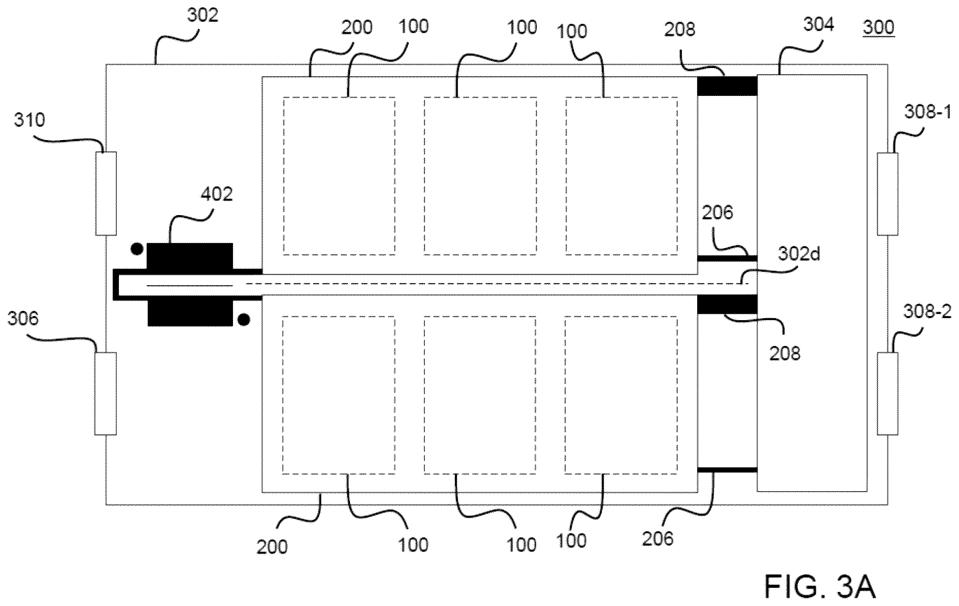

In some non-limiting embodiments or aspects, housing 202 may be configured to hold at least one (e.g., a plurality of, a set of, and/or the like) energy storage modules 100. For example, as shown in FIG. 2A, housing 202 may be shaped to have three energy storage modules 100 uniformly distributed in an interior space defined by housing 202. In some non-limiting embodiments or aspects, there may be any number of energy storage modules 100, as described herein. For example, housing 202 may contain six energy storage modules 100, nine energy storage modules 100, twelve energy storage modules 100, and/or the like.

In some non-limiting embodiments or aspects, bar connections 204 may connect energy storage modules 100 within housing 202. For example, as shown in FIG. 2A, a first (e.g., left) bar connection 204 may connect second electrical connection S2 of a first (e.g., left) energy storage module 100 to first electrical connection S1 of a second (e.g., center) energy storage module 100, and a second (e.g., right) bar connection 204 may connect second electrical connection S2 of the second (e.g., center) energy storage module 100 to first electrical connection S1 of a third (e.g., right) energy storage module 100. As such, these energy storage modules 100 may be connected in series. In some non-limiting embodiments or aspects, energy storage modules 100 and/or bar connections 204 may be in other arrangements and/or have other connections (e.g., to connect energy storage modules 100 in series, in parallel, a combination of series and parallel connections, and/or the like, as described herein). In some non-limiting embodiments or aspects, bar connections 204 may include a conductive (e.g., electrically conductive) material, such as metal and/or the like.

In some non-limiting embodiments or aspects, electrical connections 206 may include a conductive (e.g., electrically conductive) material, such as metal and/or the like. For example, electrical connections 206 may include a wire, a cable, and/or the like. In some non-limiting embodiments or aspects, electrical connections 206 may allow for electrical connection between energy storage module container 200 (e.g., energy storage modules 100 within energy storage module container 200) and external components (e.g., other components of the power supply system external to housing 202).

In some non-limiting embodiments or aspects, first electrical connection 206-1 may be connected to first electrical connection S1 of at least one energy storage module 100. For example, first electrical connection 206-1 may be connected to first electrical connection S1 of a first (e.g., left) energy storage module 100 (e.g., of a group of energy storage modules 100 connected in series). In some non-limiting embodiments or aspects, second electrical connection 206-2 may be connected to second electrical connection S2 of at least one energy storage module 100. For example, second electrical connection 206-2 may be connected to second electrical connection S2 of a last (e.g., right) energy storage module 100 (e.g., of a group of energy storage modules 100 connected in series).

In some non-limiting embodiments or aspects, communication connection 208 may include at least one component that permits communication among other components. For example, communication connection 208 may include a bus connection (e.g., digital bus, such as controller area network bus (CAN-bus), isolated serial port Interface (isoSPI), any derivatives thereof, any combination thereof, and/or the like). In some non-limiting embodiments or aspects, communication connections 208 may allow for communicative connection between container energy storage modules 100 within energy storage module container 200 (e.g., module controllers 103 of such energy storage modules 100) and external components (e.g., other components of the power supply system external to housing 202, such as a system controller and/or the like). The system controller may provide a signal (e.g., command) via communication connection 208 to any of module controllers 103 for operating the switching elements 110 thereof (e.g., via one or more gate driver circuits) in a particular (e.g., controlled) manner.

FIGS. 2B-2C provide schematic diagrams of an example energy storage module container 200 of energy storage modules, according to some non-limiting embodiments or aspects. As shown in FIGS. 2A-2C, energy storage module container 200 may include at least one energy storage module 100 (e.g., a plurality or energy storage modules 100, a set of energy storage modules 100, and/or the like of), housing 202 (e.g., including top cover 202a and holder 202b), bar connections 204, first electrical connection 206-1 and second electrical connection 206-2 (collectively referred to as “electrical connections 206” and individually referred to as “electrical connection 206”), and/or communication connection 208. The number and arrangement of components shown are provided as an example. In some non-limiting embodiments or aspects, energy storage module container 200 may include additional components, fewer components, different components, or differently arranged components than those shown. Additionally or alternatively, a set of components (e.g., one or more components) of energy storage module container 200 may perform one or more functions described as being performed by another set of components of energy storage module container 200.

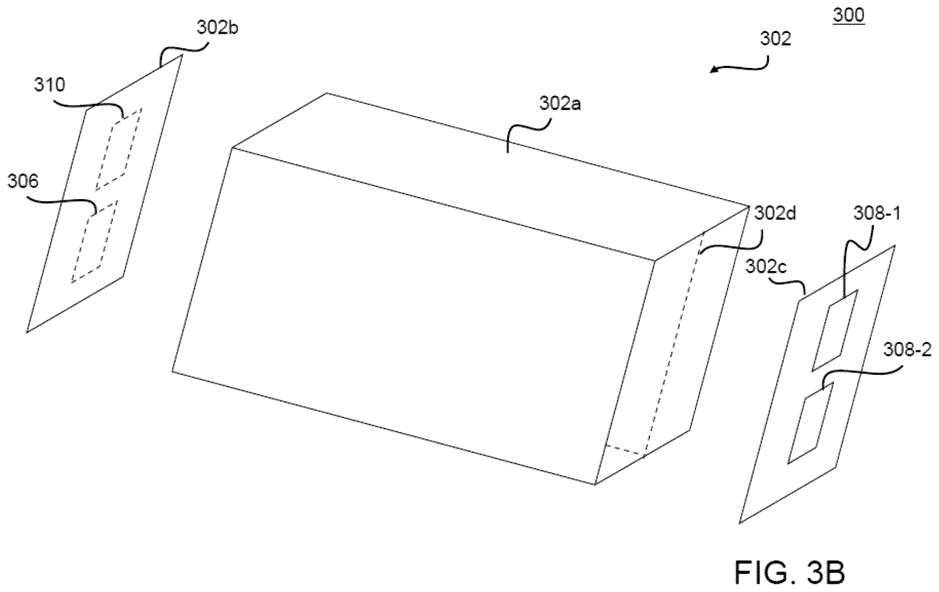

Referring now to FIGS. 3A and 3B, shown are schematic diagrams of an example electrical power system, shown here as a power supply system 300, according to some non-limiting embodiments or aspects. As shown in FIGS. 3A and 3B, power supply system 300 may include at least one energy storage module container 200 (e.g., each including at least one energy storage module 100), electrical connections 206, communication connections 208, housing 302, system controller 304, input connection 306, at least one output connection (e.g., first output connection 308-1 and/or second output connection 308-2, collectively referred to as “output connections 308,” and individually referred to as “output connection 308”), and/or choke 402. In some non-limiting embodiments or aspects, power supply system 300 may also include communication connection 310. For brevity and clarity, electrical connections 206 and communication connections 208 inside energy storage module container 200 are not shown in FIG. 3A, but energy storage module(s) 100 may be connected to electrical connections 206 and/or communication connections 208, as described herein. For brevity and clarity, connections between energy storage module container 200 (and/or energy storage module(s) 100 thereof) and input connection 306, output connection(s) 308, and/or communication connection 310 are not shown in FIG. 3A, but energy storage module container 200 (and/or energy storage module(s) 100 thereof) may be connected to input connection 306, output connection(s) 308, and/or communication connection 310, as described herein. For brevity and clarity, connections between system controller 304 and input connection 306, output connection(s) 308, and/or communication connection 310 are not shown in FIG. 3A, but system controller 304 may be connected to input connection 306, output connection(s) 308, and/or communication connection 310, as described herein. The number and arrangement of components shown are provided as an example. In some non-limiting embodiments or aspects, power supply system 300 may include additional components, fewer components, different components, or differently arranged components than those shown. Additionally or alternatively, a set of components (e.g., one or more components) of power supply system 300 may perform one or more functions described as being performed by another set of components of power supply system 300. For example, in some non-limiting embodiments or aspects, choke 402 may be included in and/or a part of system controller 304.

In some non-limiting embodiments or aspects, housing 302 may include plastic, metal, any combination thereof, and/or the like. For example, housing 302 may include a metal housing, such as an aluminum housing.

In some non-limiting embodiments or aspects, housing 302 may be configured to hold at least one (e.g., a plurality of) energy storage container(s) 200 and/or at least one (e.g., a plurality of) energy storage modules(s) 100. For example, housing 302 may be configured to hold two energy storage containers 200, three energy storage containers 200, four energy storage containers 200, and/or the like. For the purpose of illustration, housing 302 may be configured to hold two energy storage containers 200, each of which may hold twelve energy storage modules(s) 100 (e.g., a total of 24 energy storage modules(s) 100). For the purpose of illustration, housing 302 may be configured to hold three energy storage containers 200, each of which may hold eight energy storage modules(s) 100 (e.g., a total of 24 energy storage modules(s) 100). Other non-limiting configurations are also possible, e.g., housing 302 may hold four energy storage containers 200, each of which may hold six energy storage modules(s) 100 (e.g., a total of 24 energy storage module(s) 100). For the purpose of illustration, housing 302 may be configured to hold two energy storage containers 200, each of which may hold three energy storage modules(s) 100 (e.g., a total of 6 energy storage modules(s) 100). In some non-limiting embodiments or aspects, energy storage container(s) 200 and/or energy storage module(s) 100 may be in other arrangements within housing 302.

In some non-limiting embodiments or aspects, housing 302 may include a plurality of compartments separated by dividers 302d (e.g., walls, barriers, and/or the like). For example, the number of compartments may be equal to the number of energy storage container(s) 200 (e.g., a respective compartment for each respective energy storage container 200). Each compartment may be separated from the adjacent compartment(s) by a divider 302d. For example, one divider 302d may separate an interior space of housing 302 into two compartments, two dividers 302d may separate an interior space of housing 302 into three compartments, and so on. In some non-limiting embodiments or aspects, divider 302d may be part of housing 302 and/or may include the same material as housing 302 (e.g., aluminum, metal, plastic, and/or the like).

In some non-limiting embodiments or aspects, as shown in FIG. 3B, housing 302 may include body 302a, first end cap 302b, second end cap 302c, and/or at least one divider 302d. In some non-limiting embodiments or aspects, body 302a and/or divider 302d may include a first material (e.g., metal, such as aluminum), and first end cap 302b and/or second end cap 302c may include a second material (e.g., plastic). In some non-limiting embodiments or aspects, at least one of first end cap 302b and/or second end cap 302c may include the same material as body 302a and/or divider 302d. In some non-limiting embodiments or aspects, first end cap 302b and second end cap 302c may be configured to (e.g., sized and shaped to) cover openings at respective ends of body 302a.

In some non-limiting embodiments or aspects, first end cap 302b and/or second end cap 302c may include (and/or may have a space to accommodate) input connection 306, output connection(s) 308, and/or communication connection 310. For the purpose of illustration, as shown in FIG. 3B, input connection 306 and communication connection 310 may be located at first end cap 302b, and output connections 308 may be located at second end cap 302c. In some non-limiting embodiments or aspects, input connection 306, output connection(s) 308, and/or communication connection 310 may be in other arrangements. For example, all of input connection 306, output connection(s) 308, and communication connection 310 may be located at the same end cap (e.g., one of first end cap 302b or second end cap 302c). As another example, input connection 306 may be located at one end cap, and communication connection 310 and output connection(s) 308 may be located at the other end cap. As another example, input connection 306 and output connection(s) 308 may be located at one end cap, and communication connection 310 may be located at the other end cap. As another example, first output connection 308-1 may be located at one end cap, and second output connection 308-2 may be located at the other end cap.

In some non-limiting embodiments or aspects, system controller 304 may include a controller and associated circuitry. For example, system controller 304 may include a microcontroller, a computing device, a processor, a microprocessor, a digital signal processor (DSP), and/or any processing component (e.g., a field-programmable gate array (FPGA), an application-specific integrated circuit (ASIC), etc.) that can be configured to perform at least one function. In some non-limiting embodiments or aspects, system controller 304 may be communicatively connected to energy storage module container 200 and/or energy storage module(s) 100 (e.g., module controller(s) 103 thereof) by communication connection 208. In some non-limiting embodiments or aspects, system controller 304 may be electrically connected to energy storage module container 200 and/or energy storage module(s) 100 (e.g., energy storage component(s) 102 thereof) by electrical connection(s) 206. In some non-limiting embodiments or aspects, choke 402 may be included in and/or a part of system controller 304.

In some non-limiting embodiments or aspects, input connection 306 may include at least one connector (e.g., at least one standardized electrical plug connector, e.g., for mains electric power and/or electrical devices compatible therewith). In some non-limiting embodiments or aspects, each output connection 308 may include at least one connector (e.g., at least one standardized electrical plug connector, e.g., for mains electric power and/or electrical devices compatible therewith). For example, first output connection 308-1 may include a connector (e.g., standardized electrical plug connector) suitable for 100-127 V (e.g., at a frequency of 60 Hz suitable for the United States of America, North America, etc.). For example, second output connection 308-2 may include a connector (e.g., standardized electrical plug connector) suitable for 200-240 V (e.g., at a frequency of 50 Hz suitable for the European Union, etc.). In some non-limiting embodiments or aspects, communication connection 310 may include at least one connector (e.g., at least one standardized communication plug connector). For example, communication connection 310 may include at least one of a universal serial bus (USB) connector (e.g., USB-A, USB-B, USB-C, USB power delivery (USB-PD), mini-USB, micro-USB, and/or the like), an ethernet connector, a coaxial cable connector, a pin connector, a CAN-bus connector, any combination thereof, and/or the like.

In some non-limiting embodiments or aspects, choke 402 may be electrically connected (e.g., coupled and/or the like) to energy storage module container(s) 200 and/or energy storage module(s) 100, as described herein. For example, a first energy storage module container 200 and/or a first set of energy storage modules 100 may be connected to a first connection (e.g., first end, first winding, and/or the like) of choke 402, as described herein. Additionally or alternatively, a second energy storage module container 200 and/or a second set of energy storage modules 100 may be connected to a second connection (e.g., second end, second winding, and/or the like) of choke 402, as described herein.

In some non-limiting embodiments or aspects, system controller 304 may command module controller(s) 103 of energy storage module(s) 100 to generate an output voltage based on a combination (e.g., sum and/or the like) of the respective module voltage of each respective energy storage module 100, as described herein. For example, by sequentially connecting multiple energy storage module(s) 100 in series in a time-shifted manner, a combined (e.g., summed) voltage may approximate an AC voltage waveform having a target amplitude (e.g., a voltage substantially equal to the nominal voltage of mains electric power, such as 100-127 V, 200-240 V, and/or the like) and/or a target frequency (e.g., a frequency substantially equal to the nominal frequency of mains electric power, such as 60 Hz, 50 Hz, and/or the like), as described herein.

In some non-limiting embodiments or aspects, system controller 304 may command module controller(s) 103 of energy storage module(s) 100 to cause a respective duty cycle of a respective module voltage of each respective energy storage module 100 to generate an output voltage based on a combination (e.g., sum and/or the like) of the respective module voltage of each respective energy storage module 100, as described herein. For example, by modulating the duty cycle differently for multiple energy storage module(s) 100 connected in series, a combined (e.g., summed) voltage may approximate (e.g., better approximate) an AC voltage waveform having a target amplitude and/or a target frequency, as described herein. In some non-limiting embodiments or aspects, the duty cycle of the respective module voltage may relate to a switched voltage scheme such as a pulse-width modulation (PWM) type waveform. For example, system controller 304 may command module controller(s) 103 of energy storage modules 100 to switch their output voltage with certain frequency and/or duty-cycle. The exact number or range of the switching frequency is not essential to the scope or generality of the teachings of the present disclosure. As some non-limiting examples, the switching frequency of the system may be in the kHz range (1 kHz to 999 kHz). For example, the switching frequency and/or PWM frequency of the system may be between 40 kHz and 100 kHz. In some cases, the switching frequency and/or PWM frequency of the system may be at or around 90 kHz. In some non-limiting embodiments or aspects, module output may be switching (e.g., PWM) at a frequency between 1.5 kHz to 7.5 kHz. For example, module output may be switching (e.g., PWM) at a frequency between 3.5 kHz to 4.5 kHz. As a further example, module output may be switching (e.g., PWM) at a frequency at or around 3.75 kHz. As another example, module output may be switching (e.g., PWM) at a frequency at or around 4 kHz. In some non-limiting embodiments or aspects, the switching frequency or PWM frequency of the system may be proportional to a multiplication of the switching frequency and/or PWM frequency of the energy storage module 100 and the number of energy storage modules 100. It shall be appreciated that duty cycle may be anywhere between 0% and 100%, e.g., depending on the time at which the respective energy storage modules 100 are being operated. For example, 0% duty cycle for a given energy storage module 100 may mean that the energy storage module 100 is instructed to be deactivated or in a bypass mode (energy storage module 100 not contributing to the output voltage, but still able to carry current), and 100% duty cycle may mean that that energy storage module 100 is instructed to be switched on or activated in a given polarity. For example, by sweeping the duty cycle of a given energy storage module 100 over time (e.g., between 0% and 100%), the effective output voltage of that energy storage module 100 can be more finely incremented or decremented between voltage steps associated with full switching between two consecutive energy storage modules 100. Various energy storage modules 100 may be orchestrated, e.g., by system controller 304, to generate an output voltage based on a combination of the respective module voltage of each respective energy storage module 100, as described herein.

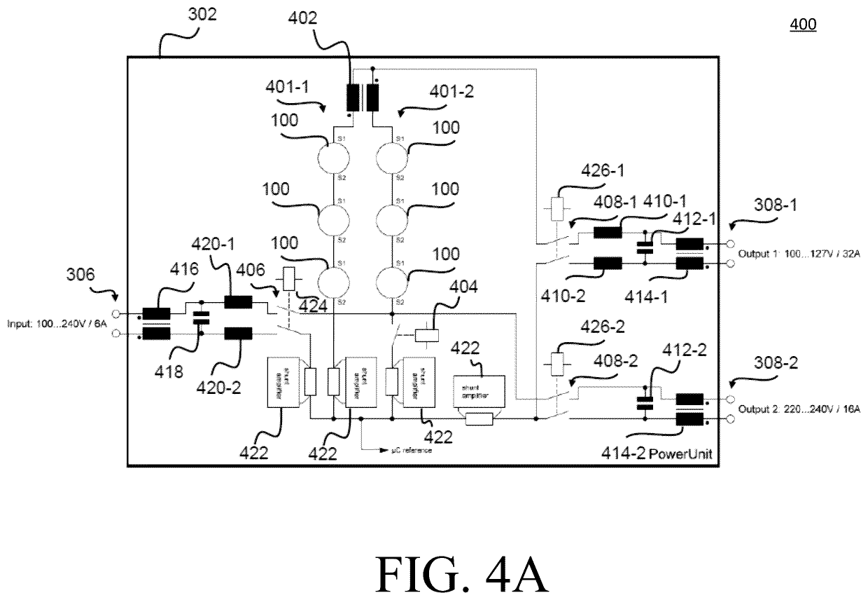

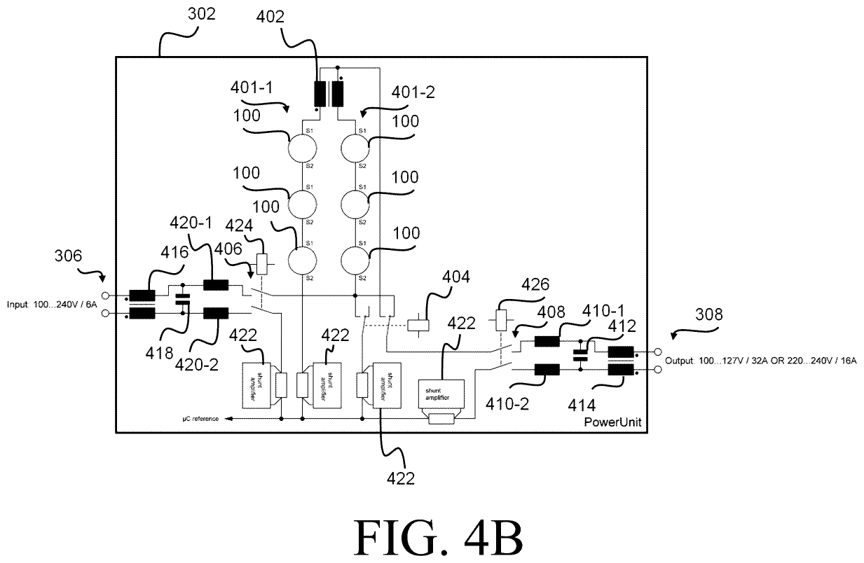

Referring now to FIG. 4A, shown is a circuit diagram of an example power supply system 400, according to some non-limiting embodiments or aspects. The present solution is not limited to the circuit architecture shown in FIG. 4A. For example, certain components of the power supply system may be optional. The optional components can include, but are not limited to, components 308-2, 408-1, 412-2, 414-2. FIG. 4B shows the power supply system without these components.

In some non-limiting embodiments or aspects, power supply system 400 may be the same as or similar to power supply system 300. The number and arrangement of components shown are provided as an example. In some non-limiting embodiments or aspects, power supply system 400 may include additional components, fewer components, different components, or differently arranged components than those shown. Additionally or alternatively, a set of components (e.g., one or more components) of power supply system 400 may perform one or more functions described as being performed by another set of components of power supply system 400.

In some non-limiting embodiments or aspects, as shown in FIG. 4, input connection 306 may be connected to input choke 416. Input choke 416 may be connected to input capacitor 418 and/or at least one input inductor (e.g., first input inductor 420-1 and/or second input inductor 420-2, collectively referred to as “input inductors 420,” and individually referred to as “input inductor 420”). For example, input choke 416 may be provided for electromagnetic compatibility (EMC) reasons. Similarly, input capacitor 418 may be provided as an EMC capacitor (and/or class-X capacitor), which may stabilize the input voltage and/or make the input less impedant at higher frequencies. For example, input inductor(s) 420 may be used to operate the electrical system 400 in a controlled current mode.

In some non-limiting embodiments or aspects, first output connection 308-1 may be connected to first output choke 414-1. First output choke 414-1 may be connected to at least one of capacitor 412-1 and/or inductors 410.

In some non-limiting embodiments or aspects, second output connection 308-2 may be connected to second output choke 414-2. Second output choke 414-2 may be connected to capacitor 412-2.

In some non-limiting embodiments or aspects, each of the chokes (e.g., input choke 416, first output choke 414-1, and/or second output choke 414-2) may be common-mode chokes and/or the like, e.g., used for EMC performance. It shall be appreciated that further discussion of EMC inductors or capacitors is not essential to the scope or generality of the present teachings.

In some non-limiting embodiments or aspects, input switch 424 may selectively connect and/or disconnect input 406 from first set 401-1 and second set 401-2 of energy storage modules 100. In some non-limiting embodiments or aspects, to operate in a third mode of operation (e.g., a charging mode of operation) input switch 424 at input 406 may be switched to a first state (e.g., closed, activated, and/or the like). For example, switching input switch 424 to the first state (e.g., closed, activated, and/or the like) may allow current to flow from input connection 306 through input 406 to first set 401-1 and second set 401-2 of energy storage modules 100 (e.g., to charge energy storage modules 100). In some non-limiting embodiments or aspects, a power source (e.g., mains electric power, generator power, renewable power (e.g., solar, wind, and/or the like), and/or the like) may be connected to input connection 306. In some non-limiting embodiments or aspects, system controller 300 may control module controllers of energy storage modules 100 to charge energy storage components 102 thereof (e.g., based on power from the power source).

In some non-limiting embodiments or aspects, to discontinue the third mode of operation (e.g., stop charging) and/or to prevent current from flowing to input connection 306 when power supply system 400 is not in the third (e.g., charging) mode of operation, input switch 424 at input 406 may be switched to a second state (e.g., open, deactivated, and/or the like).

In some non-limiting embodiments or aspects, at least one output switching element (e.g., first output switch 426-1 and/or second output switch 426-1, collectively referred to as “output switches 426,” and individually referred to as “output switch 426”) may selectively connect and/or disconnect outputs 408 from first set 401-1 and second set 401-2 of energy storage modules 100.

In some non-limiting embodiments or aspects, to operate in the first mode of operation, in addition to switching of switch 404 to a first state (e.g., closed, activated and/or the like), first output switch 426-1 may be switched to a first state (e.g., closed, activated and/or the like). For example, this may allow current to flow from first set 401-1 and second set 401-2 of energy storage modules 100 through first output 408-1 (and inductors 410 and/or capacitor 412-1) to first output connection 308-1 (e.g., to supply power to a load connected to first output connection 308-1). In some non-limiting embodiments or aspects, to prevent current from flowing to first output connection 308-1 when power supply system 400 is not in the first mode of operation, first output switch 426-1 may be switched to a second state (e.g., opened, deactivated and/or the like).

In some non-limiting embodiments or aspects, to operate in the second mode of operation, in addition to switching of switch 404 to a second state (e.g., opened, deactivated and/or the like), second output switch 426-2 may be switched to a first state (e.g., closed, activated and/or the like). For example, this may allow current to flow from first set 401-1 and second set 401-2 of energy storage modules 100 through second output 408-2 (and capacitor 412-2) to second output connection 308-2 (e.g., to supply power to a load connected to second output connection 308-2). In some non-limiting embodiments or aspects, to prevent current from flowing to second output connection 308-2 when power supply system 400 is not in the second mode of operation, second output switch 426-2 may be switched to a second state (e.g., opened, deactivated and/or the like).

In some non-limiting embodiments, the first mode of operation and the second mode of operation may be used to provide multi-voltage operation via the power supply system 400. For example, in the first mode of operation, the first set 401-1 and second set 401-2 of energy storage modules 100 may be connected in parallel, while in the second mode of operation, the first set 401-1 and second set 401-2 of energy storage modules 100 may be connected in series. It shall be appreciated that the first mode of operation may be provide an output voltage which is lower than the output voltage provided in the second mode of operation, however the output current provided in the first mode of operation may be larger than the output current provided in the second mode of operation. For example, the first mode of operation may provide an 110 V output, while the second mode of operation provides a 220 V output. This can advantageously allow the power supply system 400 for multi-voltage domain operation. For example, 110 V AC mains voltage domain is predominantly used in the US, while 220 V AC mains voltage domain is used in Europe. The power supply system 400 can thus allow flexibility in using electrical appliances rated for any of the voltage domains. A particular advantage of the shown configuration can be that output power can be similar or identical in either mode. For example, assuming identical sets (401-1 and 401-2) operating identically, output current in the first mode can be double of the output current in the second mode even though the output voltage in the first mode is half of the output voltage in the second mode. This can allow similar power levels to be used despite the voltage domain which the power supply system 400 output is operating in. The examples of 110 V and 220 V are non-limiting to the teachings as any voltage domain, or operating frequency can be realized with the present structure. Moreover, it is not limiting to have the two domains which are related by an integer factor to each other in terms of voltage and/or current. It shall be appreciated the operating cycle (e.g., order of plurality of modules) can be adapted according to the operating mode of the power supply system 400.

In some non-limiting embodiments or aspects, each of input switch 424 and output switches 426 may include at least one of a switch, a contactor, a transistor, any combination thereof, and/or the like. For example, each of input switch 424 and output switches 426 may include at least one of an SPST switch, a DPDT switch, an SPDT switch, a DPST switch, any combination thereof, and/or the like. For example, each of input switch 424 and output switches 426 may include at least one of a DPDT switch or a DPST switch. For the purpose of illustration, as shown in FIG. 4, each of input switch 424 and output switches 426 may include a DPST switch or a DPDT switch.

In some non-limiting embodiments or aspects, power supply system 400 may include current sensors 422, which may be in communication with system controller 304 (e.g., a microcontroller). In some non-limiting embodiments or aspects, each current sensor 422 may include a shunt amplifier. For example, each shunt amplifier may refer to a common potential (e.g., reference voltage), to which system controller 304 (e.g., a microcontroller) also may refer. In some non-limiting embodiments or aspects, at least some (e.g., all, a subset, and/or the like) of current sensors 422 may be any other suitable type of current sensor. For example, a current sensor 422 may include measuring voltage drop across a resistor connected in series (e.g., to at least one of first set 401-1 and/or second set 401-2 of energy storage modules 100), e.g., to measure the current flowing through the resistor (and/or any component in series with the resistor). In some non-limiting embodiments or aspects, at least one current sensor 422 may be of a different type than another current sensor 422. For example, a current sensor 422 connected to of first set 401-1 of energy storage modules 100 may be of a different type than another current sensor 422 connected to second set 401-2 of energy storage modules 100.

In some non-limiting embodiments or aspects, by measuring current at locations of current sensors 422, the following may be measured (e.g., by system controller 304 and/or the like): output current (e.g., in a redundant manner), input current (e.g., in a redundant manner), circular current (e.g., if strings are connected in parallel). In some non-limiting embodiments or aspects, current sensors may measure current flowing through each of first set 401-1 and second set 401-2 of energy storage modules 100. As such, relative measurements may be performed to detect if a circular (e.g., loop) current is flowing between first set 401-1 and second set 401-2 of energy storage modules 100. In other words, such relative measurements may be used to detect that the load current is divided evenly between the sets. Such measurements also may be used for orchestrating the operation of energy storage modules 100, e.g., in such a manner that the circular (e.g., loop) current may be reduced (e.g., eliminated). Additionally or alternatively, such orchestration may also include disabling certain energy storage modules 100 in any of sets 401, even if such disabling causes an unequal number of active energy storage modules 100 between the sets 401. This may help running the system 400, for example, even if energy storage modules 100 between sets 401 have different charge levels. Additionally or alternatively, such orchestration may include first module voltages of first set 401-1 being interleaved with second module voltages of second set 401-2. Interleaving of the module voltages can be done by phase shifting output voltage of one set with respect to the output of the other set. Additionally or alternatively, such orchestration may include tolerating, or even in some non-limiting embodiments or aspects, creating, an imbalance in voltages between the first set 401-1 and the second set 401-2. This may result in the loop current which tends to flow from one set 401 to the other set 401 to be a low frequency current which can be used, e.g., to equalize state of charge between the two sets 401. Choke 402, even in such non-limiting embodiments or aspects, may block the high frequency currents, but may allow low frequency or DC current to flow from the set 401 having a higher voltage than the other set 401. As such, power supply system 400 may be more robust, flexible, and balanced. In some non-limiting embodiments or aspects, current sensors 422 may be leveraged for making absolute measurements, such as determining total current flowing through first set 401-1 and/or second set 401-2 of energy storage modules 100. It shall be appreciated that said imbalance may be caused by unequal number of energy storage modules 100 operating in one set 401 as compared to the number of energy storage modules 100 operating in the other set 401. Additionally or alternatively, the imbalance may be due to unequal charge level between the two sets 401. Similarly, the power supply system 400 may also include circuit for voltage measurement in one or more networks of the power supply system 400. It is neither essential nor limiting to the present disclosure to specify which voltage measurement circuit or scheme must be used.

It should be noted that the second output circuitry 408-2, 412-2, 414-2, 426-2, 308-2 may be optional. Accordingly, the present solution is discussed below in relation to the first output circuitry 408-1, 410-1, 410-2, 412-1, 414-1, 426-1, 308-1. The present solution will also be discussed in relation to the input circuitry 306, 416, 418, 420-1, 420-2. The particulars of the present solution will become evident as the discussion progresses.

As discussed above, the power supply system 300, 400 may comprise a buck-type inverter implemented as a modified cascaded H-bridge (MCHB) inverter. The MCHB inverter comprises the transistor active bridge circuits 144 of the energy storage modules 100 and the coupled inductor. Each H-bridge of the transistor active bridge circuits 144 may be referred to herein as an inverter. The power supply system is configured to operate in a first mode and a second mode. In the first mode, the MCHB inverter is operated in a current-controlled manner. The first mode may be employed, for example, when battery cells in a plurality of energy storage modules 100 are charging while the MCHB inverter terminals are connected to an AC-input 306 of the power supply system. In the second mode, the MCHB inverter is operated in a voltage-controlled manner. The second mode may be employed, for example, when power is being supplied (e.g., 120V or 240V) to another device coupled to an AC-output 308-1 or 308-2 of the power supply system by further connecting the MCHB inverter terminals to said AC-output.

All modes of operation may be governed by a high order control loop characterized in that: (i) there is at least one complex-conjugate pole pair below the unity loop gain frequency (ULGF) but well above DC and also well above the output voltage/current frequency of 50/60 Hz (e.g., at 350 Hz for voltage and 100 Hz for current); (ii) there is at least one real zero well above the pole frequency and well below the unity gain frequency thereby compensating the roll-off of at least one pole thereby ensuring stable operation; and (iii) there is a scheme for partially saturating the integrating elements in order to tackle problems arising from conditional stability. The complex-conjugate pole pair may be implemented as a second order low pass filter. Item (ii) may refer to a response of a second order low pass filter that meets (e.g., is equal to or is additively combined with) another response of a lower order at some frequency.

The high-order voltage control loop is configured to govern the instantaneous output voltage of the MCHB inverter. The inverter takes a ‘command voltage’ as input value and determines a duty cycle for the switching stages based on energy storage module data. The energy storage module data can include, but is not limited to, battery data. However, errors may occur in this process since (besides other effects) the battery cells (and other components in the power path) come with a parasitic resistance that causes the actual output voltage to be distorted by a voltage drop caused by a load current. The difference between a desired voltage and the actual voltage is considered an error signal. The task of the high-order voltage control loop is to shape the error signal in the frequency domain. Spectral energy of the error signal below unit loop gain frequency (ULGF) will be shifted to frequencies above ULGF.

### Voltage Loop

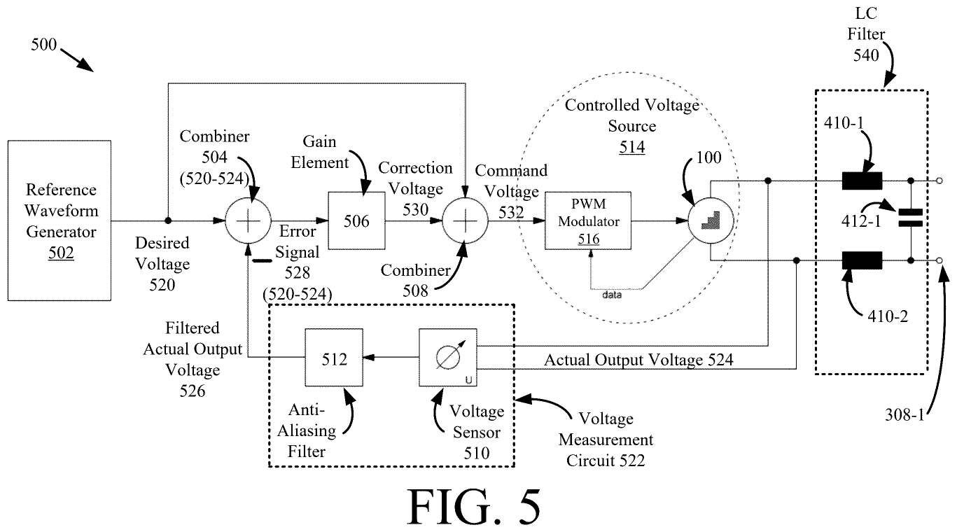

FIG. 5 provides a circuit diagram of a high-order voltage control loop (HOVCL) 500. Pursuant to a non-limiting aspect of the present teachings, HOVCL 500 is provided to compensate for the non-idealities in the system. For example, effects of parasitic resistance to the output voltage of energy storage module(s) 100 when load current is being drawn. This inner parasitic resistance is not well defined because it depends on age, state of charge, etc. In such cases, the HOVCL 500 is provided to stabilize the output voltage of each energy storage module(s) 100 by ensuring that it is similar to a reference waveform. In effect, the system can draw any amount of load current without having any or a minimal amount of change in its output voltage. In this way, the HOVCL 500 can compensate for the inner parasitic resistance, and effectively reduce its effects to be eliminated or be relatively small.

HOVCL 500 comprises a controlled voltage source (CVS) 514. CVS 514 comprises a PWM modulator 516 that is configured to consume a command voltage 532 and battery data in order to determine the right PWM drive signals (duty cycle) for the energy storage module in 100. In 100, the PWM signals are combined with the battery pack voltage(s) resulting in an actual output voltage—of which the average within one PWM cycle is equal to the command voltage. The actual output voltage is passed to an LC circuit 540 for filtering thereof prior to being provided to a load (not shown) that is connected to output terminals 308-1.

In some scenarios, the desired output voltage may be, for example, 60 V and the energy storage cell may have, for example, 100 V of battery voltage. The PWM modulator 516 determines that, in order to provide the 60 V output, the energy storage cell 100 is to be ON or connected for 60% of a cycle or timeslot, and is to be OFF or disconnected for the remaining 40% of the cycle or timeslot. In an ideal case, the energy storage module 100 produces 60 V at its output. However, current is drawn from the voltage source when a load is connected to the output terminals 308-1. This causes the output voltage of the energy storage module 100 to be lowered. Thus, HOVCL 500 comprises additional components 504, 506, 508, 522 to address this issue by adjusting a desired voltage waveform by the actual output voltage to compensate for the lowering of the voltage due to the current draw. The present solution is not limited to the particulars of this scenario.

As shown in FIG. 5, a reference waveform generator (RWG) 502 is configured to generate a desired voltage or reference waveform signal 520 as, for example, a sinusoidal waveform that is fed forward in a first path to an input of the CVS 514. This ensures that even if the output of a gain element (GE) 506 is saturated to a predetermined value the output voltage of the energy storage module 100 will more or less follow an output voltage of the RWG 502.

A voltage measurement circuit (VMC) 522 acquires an actual output voltage 524 of the energy storage module 100 (before being filtered by the LC filter 540) and applies anti-aliasing filtering (AAF) at block 512 thereto to generate a filtered actual output voltage 526. A voltage sensor 510 may be provided for measuring voltage and converting the measured voltage into another voltage. Operations of blocks 510, 512 may be performed by a single components rather than two components as shown in FIG. 5.

The desired voltage 520 and the filtered actual output voltage 526 are passed to a combiner 504. The combiner 504 performs operations to subtract the filtered actual output voltage 526 from the desired voltage 520. The result from this subtraction operation is referred to as error signal 528. The error signal 528 is passed to GE 506.

The GE 506 performs operations to apply a filtering function to the error signal 528 to generate a correction voltage or signal 530. The filter function may amplify low-frequency portions of the error signal and attenuate high-frequency portions of the error signal. It should be noted that the HOVCL is preferably conditionally stable which means that it will not oscillate under normal conditions. However, when overdriven, the HOVCL may oscillate randomly. In this regard, the GE 506 amplifies the error signal 528 for low frequency in a way that for the overall loop there is a frequency at which the open loop gain is unity (ULGF) and magnitude (e.g., absolute value) of phase shift is less (e.g., significantly less) than −180°.

The correction voltage 530 is then added to the desired voltage 520 by combiner 508 to produce command voltage or control signal 532. Command voltage 532 is passed to an input of the PWM modulator 516 of the CVS 514.

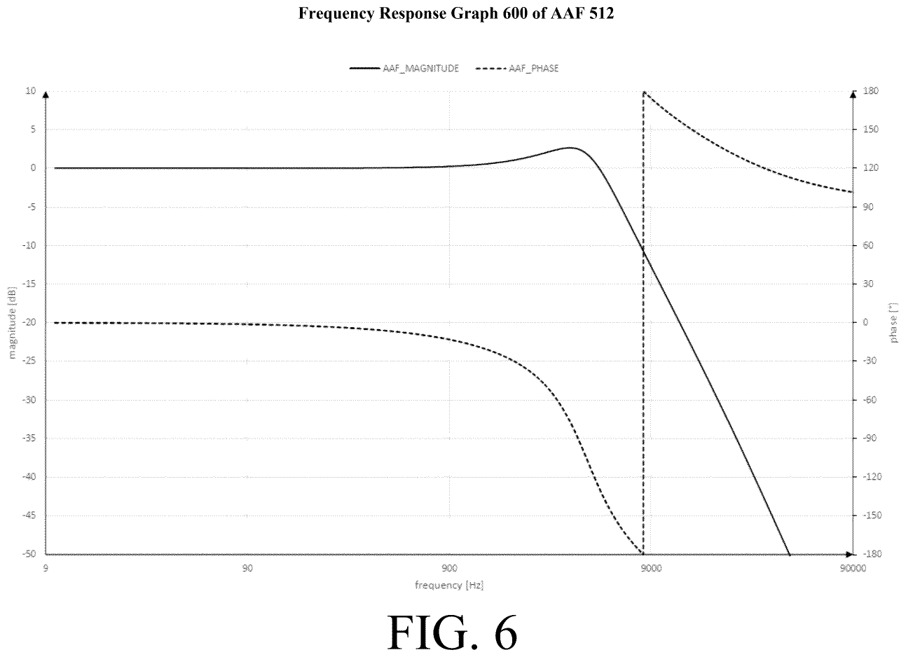

In some scenarios, the HOVCL may operate in a digital domain. In this regard, the signal is band-limited in order to meet the Nyquist criterion (AAF-aspect). This is achieved using an analog filter of third order for the AAF 512. The components may be tuned in accordance with a particular application. For example, the components may be tuned so that the filter response meets the following requirements: 50 dB damping at the Nyquist frequency of 45 kHz; max. overshoot <3 dB; phase error at 60 Hz <1°; and gain such that 1 digit (of 12-bit ADC) equals 221.6 mV. An illustrative frequency response of the AAF 512 is shown in graph 600 of FIG. 6.

In order to maximize computational efficiency, the transfer function of GE 506 may comprise a linear combination of digital integrators. On some processors, the digital integrators may be executed in one instruction cycle using a MAC-operation. Each digital integrator comprises a defined gain which adjusts an integration time constant. Operations of the digital integrator can be defined by the following mathematical equation (1).

$$H ( z ) = \frac{\frac{{k}_{s}}{{f}_{s}}}{1 - {z}^{- 1}} \qquad ( 1 )$$

in z-domain notation, where kᵢ represents an integrator gain, ƒₛ represents the sampling frequency. The sampling frequency ƒₛ can be selected in accordance with any application. For example, the sampling frequency ƒₛ is selected as 90 kHz. The present solution is not limited to the particulars of this example. z is defined by the following mathematical equation (2).

$$z = {e}^{jw} \qquad ( 2 )$$

where j represents the imaginary unit and w is defined by the following mathematical equation (3).

$$w = 2 π ( f / {f}_{s} ) \qquad ( 3 )$$

where ƒ represents a frequency. By using the identity z=e^{jw} and w=2π(ƒ/ƒₛ), it is possible to determine a real-world frequency response of the digital integrator that is measurable using a gain-phase-analyzer.

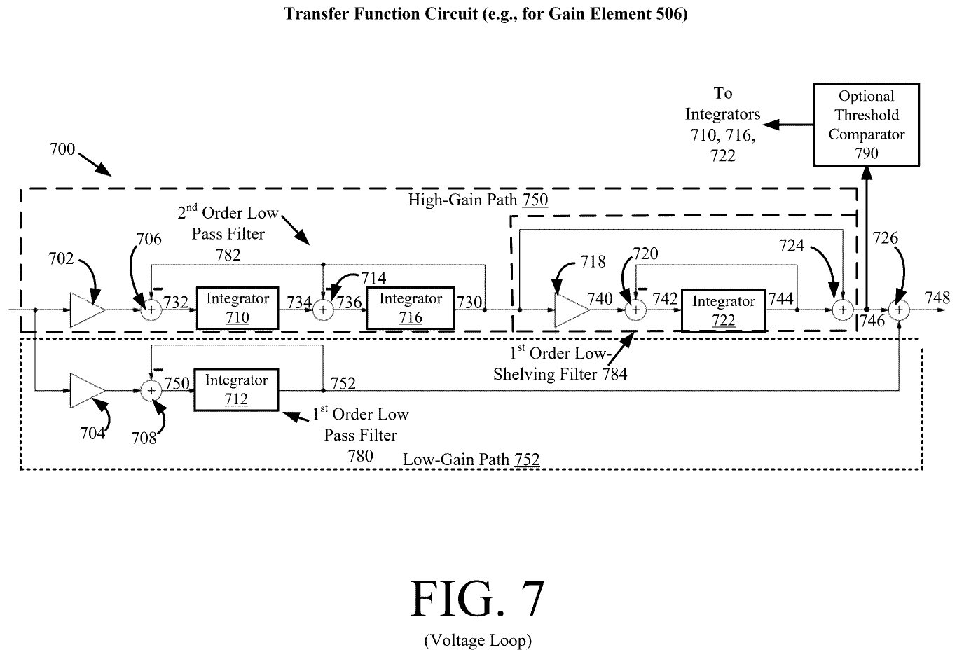

FIG. 7 provides a circuit diagram of an illustrative architecture for a transfer function circuit 700 of a GE (e.g., GE 506 of FIG. 5). Transfer function circuit 700 comprises two paths or branches 750, 752 of signal processing. The paths or branches include a high-gain path 750 and a low-gain path 752. The high-gain path 750 comprises amplifiers 702, 718, a second order low pass filter 782, a first order low-shelving filter 784, and combiner 724. Combiner 726 is not part of the high-gain path 750 or the low-gain path 752. The second order low pass filter 782 comprises combiners 706, 714 and integrators 710, 716. The first order low-shelving filter 784 comprises amplifier 718, combiners 720, 724 and integrator 722. The low-gain path 752 comprises an amplifier 704 and a first order low pass filter 780. The first order low pass filter 780 comprises a combiner 708 and an integrator 712. A direct path is also provided around the first order low-shelving filter 784.

Operations of the first order low pass filter 780 can be defined by the following mathematical equations (4)-(6).

$$H = Y / X = A / ( 1 + A ) \qquad ( 4 )$$

$$A = A ( z ) = ( {k}_{i} / {f}_{s} ) ( 1 / ( 1 - {z}^{- 1} ) ) \qquad ( 5 )$$

Setting mathematical equation (5) into mathematical equation (4) and simplifying gives mathematical equation (6).

$$H ( z ) = ( {k}_{i} / {f}_{s} ) / ( ( {k}_{i} / {f}_{s} ) + 1 - {z}^{- 1} ) \qquad ( 6 )$$

The first order low-shelving filter 784 adds a band limited amplification to the second order low-pass filter path (782) (e.g., to apply a gain of one). In this regard, the first order low-shelving filter 784 provides unity response (e.g., neither amplification nor attenuation) for high frequency components, amplification for low frequency components, and first order roll-off (e.g., −20 dB/decade) for intermediary frequency components. Operations of the first order low-shelving filter 784 may be defined by mathematical equation (7).

$$H ( z ) = G \cdot ( ( {k}_{i} / {f}_{s} ) / ( ( {k}_{i} / {f}_{s} ) + 1 - {z}^{- 1} ) ) + 1 \qquad ( 7 )$$

G represents the amplification value of amplifier 718.

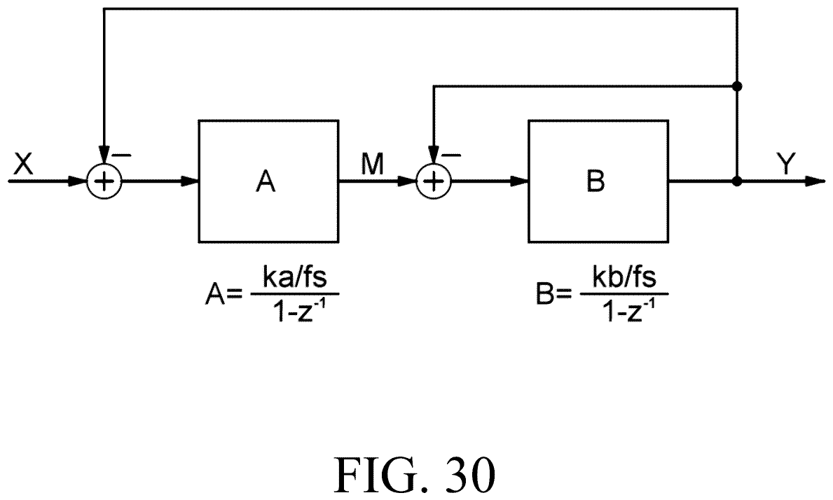

Operations of the second order low pass filter 782 may be defined by the following mathematical equations (8)-(16), which can be understand with reference to FIG. 30.

$$H = Y / X \qquad ( 8 )$$

$$Y = M \cdot ( B / ( 1 + B ) ) \qquad ( 9 )$$

$$M = A \cdot ( X - Y ) \qquad ( 10 )$$

Setting mathematical equation (10) into mathematical equation (9) provides mathematical equation (11).

$$Y = ( A \cdot ( X - Y ) ) \cdot ( B / ( 1 + B ) ) \qquad ( 11 )$$

Solving for Y provides:

$$Y = ( A \cdot B \cdot X ) / ( ( A \cdot B ) + ( B + 1 ) ) \qquad ( 12 )$$

Setting mathematical equation (12) into mathematical equation (8) provides mathematical equation (13).

$$H = ( A \cdot B ) / ( ( A \cdot B ) + ( B + 1 ) ) \qquad ( 13 )$$

$$A = A ( z ) = ( {k}_{i , A} / {f}_{s} ) ( 1 / ( 1 - {z}^{- 1} ) ) \qquad ( 14 )$$

$$B = B ( z ) = ( {k}_{i , B} / {f}_{s} ) ( 1 / ( 1 - {z}^{- 1} ) ) \qquad ( 15 )$$

By setting mathematical equations (14) and (15) into mathematical equation (13) and simplifying, mathematical equation (16) is obtained.

$$H ( z ) = ( ( {k}_{i , A} / {f}_{s} ) ( {k}_{i , B} / {f}_{s} ) ) / ( {z}^{- 2} - ( ( {k}_{i , B} / {f}_{s} ) + 2 ) {z}^{- 1} + ( ( {k}_{i A} / {f}_{s} ) ( {k}_{i , B} / {f}_{s} ) + ( {k}_{i , B} / {f}_{s} ) + 1 ) ) \qquad ( 16 )$$

During operation, an input voltage signal (e.g., error signal 528 of FIG. 5) is passed to amplifier 702 of the high-gain path 750 and amplifier 704 of the low-gain path 752. Both amplifiers 702, 704 perform operations to multiply the input voltage signal by a gain value. For example, in some scenarios, the gain value of amplifier 702 is selected to be eleven and the gain value of amplifier 704 is selected to be five. The present solution is not limited to the particulars of this example.

With regard to the low-gain path 752, the input voltage signal is amplified and passed to the first order low pass filter 780. The first order low pass filter 780 performs low pass filtering with a transfer function. In this regard, the amplified command voltage is passed to combiner 708. The combiner 708 subtracts an output voltage signal 752 of integrator 712 from the command voltage signal to obtain a combined voltage signal 750. Voltage signal 750 is passed to integrator 712. The integrator 712 performs operations defined by mathematical equations (1) to obtain an integral of the voltage signal 750 over a frequency range based on the circuit time constant. Integrator 712 has a value for parameter kᵢ that is selected in accordance with an application. For example, in some scenarios the value of kᵢ for integrator 712 is selected to be two thousand. The present solution is not limited to the particulars of this example. The voltage signal 752 is passed to combiner 726 of the high-gain path 750.

With regard to the high-gain path 750, the input voltage signal is amplified by amplifier 702 and passed to the second order low pass filter 782. The second order low pass filter 782 performs low pass filtering with transfer functions. In this regard, the amplified command voltage is passed to combiner 706. It should be noted that, with reference to above mathematical equations (8)-(16), Y equals the feedback signal 730 divided by X, where X resembles the input signal to the second order filter structure. Y is input into combiner 706. Combiner 706 subtracts its input from the command voltage to obtain combined signal 732. Combined signal 732 is passed to an input of integrator 710. Integrator 710 performs operations defined by mathematical equation (1) to obtain an integral of the voltage signal 750 over a frequency range based on the circuit time constant. Integrator 710 has a value for parameter kᵢ that is selected in accordance with an application. For example, in some scenarios, the value of k_{i,A} for integrator 710 is selected to be five thousand. The present solution is not limited to the particulars of this example. The output voltage signal 734 of integrator 710 is passed to a next combiner 714 of the second order low pass filter 782. Combiner 714 subtracts the feedback signal 730 from the output voltage signal 734 of integrator 710 to obtain a combined voltage signal 736. Combined voltage signal 736 is passed to integrator 716. Integrator 716 performs operations defined by mathematical equation (1) to obtain an integral of the combined voltage signal 736 over a frequency range based on the circuit time constant. Integrator 716 has a value for parameter k_{i,B} that is selected in accordance with an application. For example, in some scenarios, the value of kᵢ for integrator 710 is selected to be six hundred and sixty six. The present solution is not limited to the particulars of this example. The output voltage signal 730 of integrator 716 is not only fed back to combiner 732, but is also passed forward to amplifier 718 and combiner 724 in the high-gain path 750.

Amplifier 718 performs operations to multiply the incoming waveform by a gain value. The gain value can be selected in accordance with an application. For example, the gain value is selected to be four. The present solution is not limited to the particular of this example. The output voltage signal 740 of amplifier 718 is passed to the component 720 of the first order low-shelving filter 784. Components 720, 722 perform low pass filtering with a transfer function. Combiner 720 subtracts an output voltage signal 744 of integrator 722 from the output voltage signal 740 of amplifier 718 to obtain combined voltage signal 742. Voltage signal 742 is passed to an input of integrator 722. Integrator 722 performs operations defined by mathematical equation (1) to obtain an integral of the combined voltage signal 742 over a frequency range based on the circuit time constant. Integrator 722 has a value for parameter kᵢ that is selected in accordance with an application. For example, in some scenarios, the value of kᵢ for integrator 710 is selected to be one thousand. The present solution is not limited to the particulars of this example. The output voltage signal 744 of integrator 722 is not only fed back to combiner 720, but is also passed forward to an input combiner 724 in the high-gain path 750.

Combiner 724 adds the output voltage signal 730 of the second order low pass filter 782 (or integrator 716) to the output voltage signal 744 of the integrator 722. The output voltage signal 746 of the high-gain path 750 (or combiner 724) is passed to an input of a next combiner 726. Combiner 726 adds the output voltage signal 752 of the low-gain path 752 to output voltage signal 746 of the high-gain path 750 to generate voltage signal 748 which is output from the transfer function circuit 700.

The transfer function circuit 700 may also optionally comprise a threshold comparator 790 connected to the output of integrator 716. The threshold comparator 790 is configured to compare the signal 746 to a threshold value. A result of this comparison operation is provided to integrators 710 and 716 for use in controlling operations thereof.

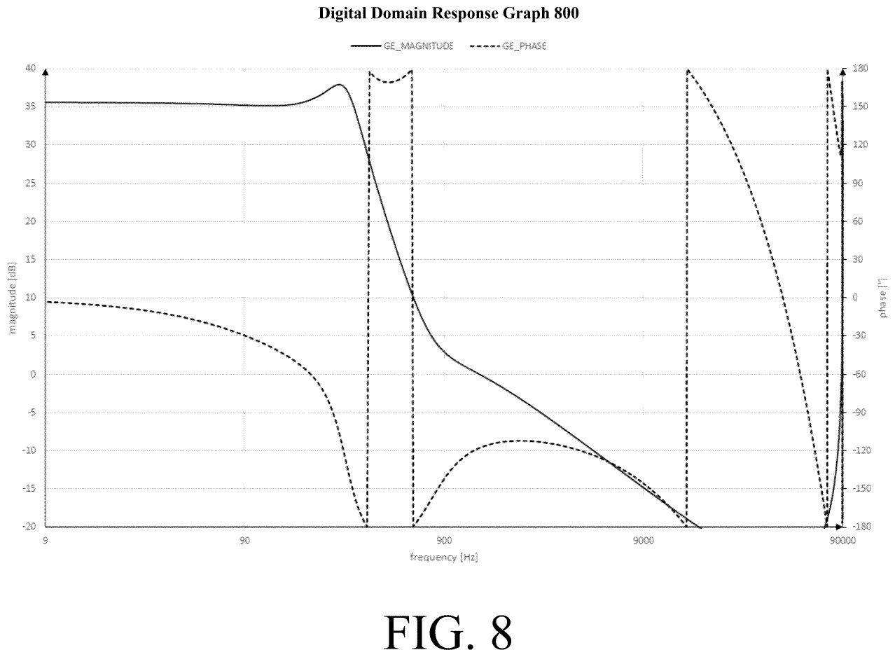

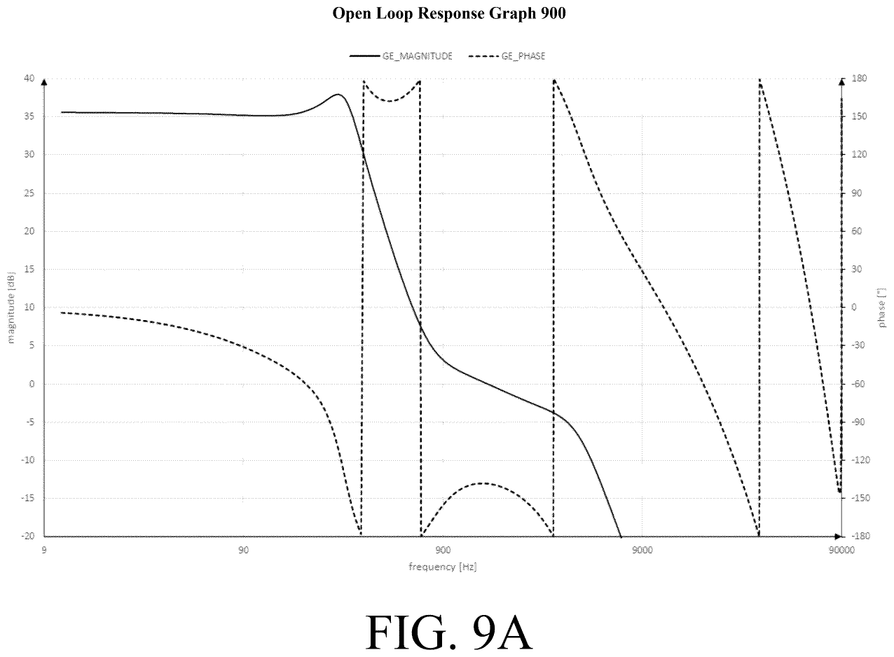

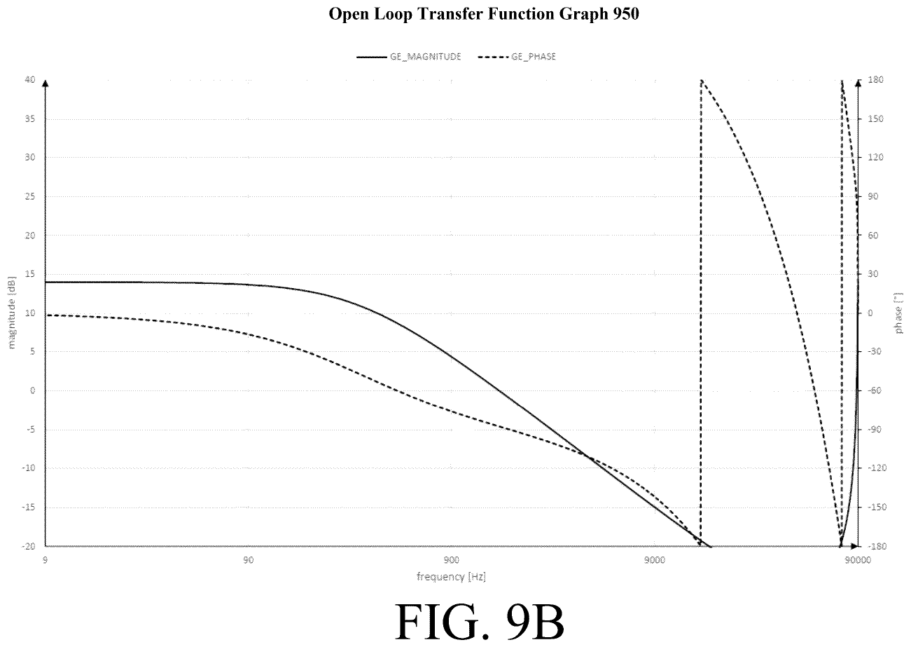

An illustrative response of the digital domain parts 502-516 of high-order voltage control loop 500 is shown in graph 800 of FIG. 8. The open loop response of circuit 500 with 700 inside 560 is to be derived by multiplying the transfer functions of FIG. 6 and FIG. 8 in the frequency domain. The open loop response is shown by graph 900 of FIG. 9A. As can be seen in FIG. 9A, ULGF is around 1.5 kHz. A phase margin is around 40°. A gain margin is around 4 dB, and a loop gain is 35 dB below 350 Hz.

Partial saturation-Voltage loop. As can be seen from FIG. 7, there is a high-gain path 750 and a low-gain path 752 being additively combined in order to derive the GE's output value 748. With reference to graph 950 of FIG. 9B, it becomes obvious that the overall loop is conditionally stable as the phase response drops below −180° where the magnitude response is above unity gain. The phase then recovers around the ULGF to values well above −180°. So under normal conditions this loop will be stable—but it might tend to oscillate under abnormal conditions (e.g., recovery from dynamic events).

One way to address this issue is partial saturation. This is done by feeding the output 746 of the high gain path through a threshold comparator 790 that: (i) causes the integrators of the high gain path to be halted; and (ii) replaces the output of the high gain path to the threshold value (e.g. +−20 V). The threshold comparator resides between combiners 724 and 726. Statement (i) may mean in digital term that new integral values are calculated according to the input value each cycle but eventually replaced by another value if the path is halted. This another value might be the last integral value stored before the path entered halted operation. The results of the comparison operation performed by threshold comparator 790 is provided to integrators 710, 716 and 722 for use in controlling operations thereof.

In some scenarios, the output of the high gain path may be limited to +−20 V. When the high-gain path is halted, the high gain path output does not contribute to the frequency response of the overall structure as it just outputs a fixed value. This action effectively reduces the order of the loop (by a number of three in this example as one complex-conjugate pole pair and one real pole are taken out of the equation). Graph 950 of FIG. 9B shows the transfer function of the loop with halted high gain path. It can be seen easily that the loop gain was reduced significantly but the loop is unconditionally stable. For example, at 0 dB gain, there is approximately −90° phase shift and phase does not drop below −180° at gains above unity.

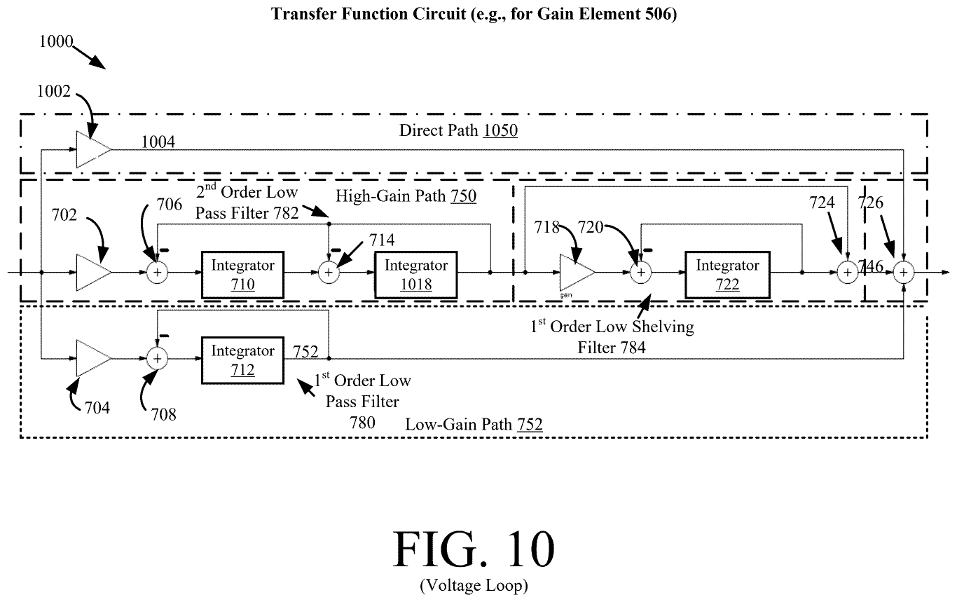

FIG. 10 provides a circuit diagram of an illustrative architecture for another transfer function circuit 1000 of a GE (e.g., GE 506 of FIG. 5). Transfer function circuit 1000 is similar to transfer function circuit 700 but has some differences. One difference is that integrator 712 has a different value selected for parameter kᵢ. For example, in some scenarios, the value of kᵢ for integrator 712 in transfer function circuit 1000 is selected to be one thousand five hundred thirty eight rather than two thousand. The present solution is not limited to the particulars of this example. Another difference is that transfer function circuit 1000 comprises an additional direct path 1050 from its input to its output. The direct path 1050 includes an amplifier 1002 to facilitate limiting the attenuation of higher frequencies. Amplifier can have a gain value selected in accordance with an application. For example, the gain value for amplifier 1002 is selected to be 0.25. The present solution is not limited in this regard.

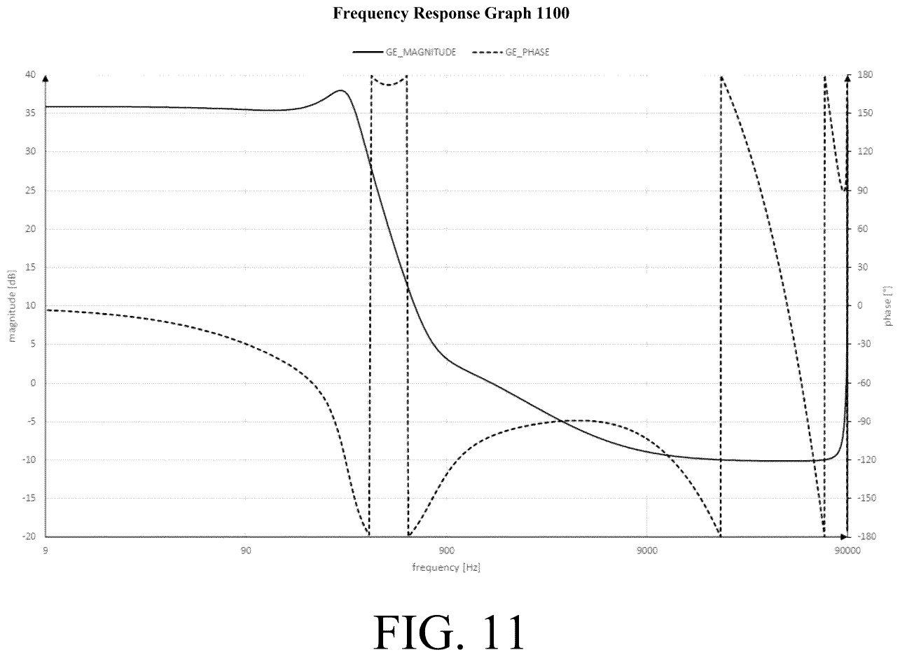

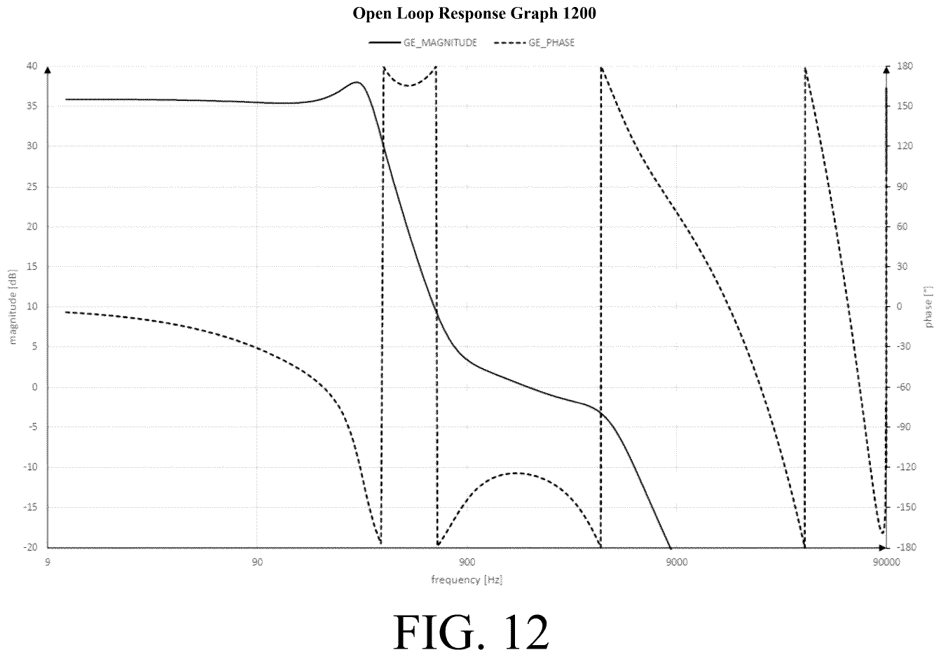

As shown in FIG. 10, the output voltage signal 1004 of the first path 1050 is added to the output voltage signals 756, 746 of the high- and low-gain paths 750, 752 (e.g., integrators 712, 722) to produce the output signal of the transfer function circuit 1009. The frequency response of the transfer function circuit 1000 is shown by graph 1100 of FIG. 11. Graph 1200 of FIG. 12 illustrates the response shown in FIG. 6 multiplied (in the frequency domain) with response shown in FIG. 11 given the open loop response of circuit 500 with 1000 inside 506.

### Current Loop

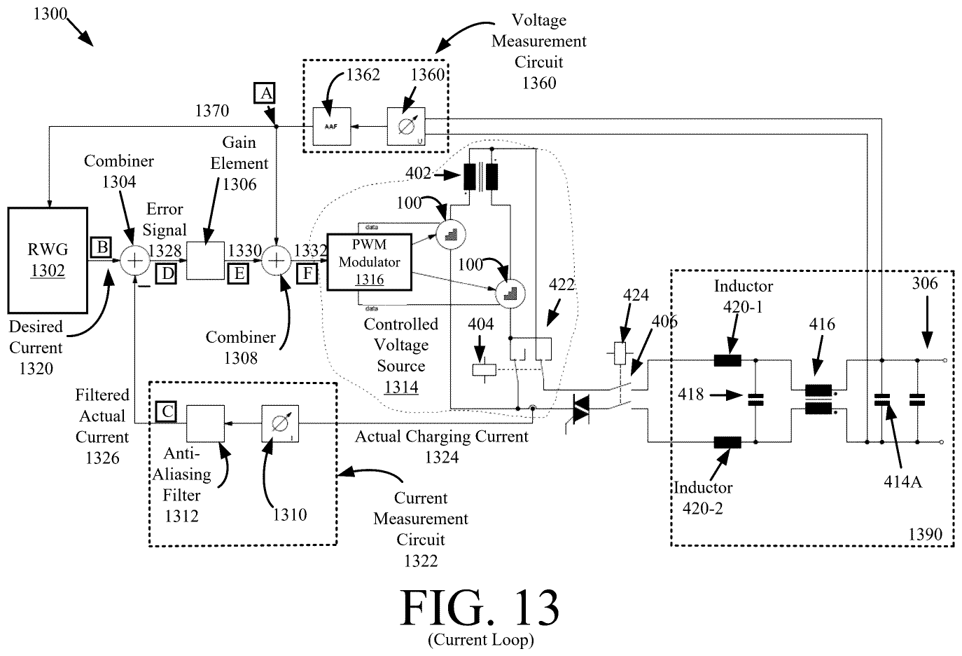

FIG. 13 provides an illustration of a current control loop (CCL) 1300. Similar to the HOVCL 500, pursuant to another non-limiting aspect of the present teachings, the CCL 1300 is provided to compensate for non-ideal effects (e.g., the effects of parasitic resistance) in the system. Moreover, the CCL 1300 can ensure that two or more energy storage modules 100 may operate in parallel with respect to their input when an incoming AC current exists. In some scenarios, the incoming AC signal may not be sinusoidal. This issue is addressed by having a relatively large gain in the CCL 1300 to ensure that an actual current waveform is not defined by the incoming AC voltage waveform. The CCL 1300 can ensure, e.g., that the actual charging current 1324 remains unaffected, or relatively unaffected, by the incoming voltage waveform.

CCL 1300 is configured to govern an instantaneous charging current from the inverter. The inverter receives a command voltage as an input value and determines a correct duty cycle for the switching stages based on energy storage module data. The energy storage module data can include, but is not limited to, battery data. A voltage difference between voltage present at the AC input 306 and the voltage output from the controlled voltage source (CVS) 1314 is converted into a current by inductors 420-1, 420-2 and parasitic resistance.

The task of CCL 1300 is to adjust the voltage difference in a way that the actual current 1324 matches a desired current or reference waveform signal 1320 as close as possible (at relevant frequencies). To do so, the difference between desired current 1320 and actual current 1324 is considered an error signal 1328. Error signal 1328 is passed to a gain element (GE) 1306 where its spectral energy is shaped.

During operation, a current measurement circuit 1322 acquires an actual charging current 1324 and applies anti-aliasing filtering (AAF) thereto in block 1312 to generate a filtered actual current 1326. A voltage sensor 1310 may be provided for measuring voltage. The output current 1326 of anti-aliasing filter (AAF) 1312 is passed to combiner 1304.

A reference waveform generator (RWG) 1302 generates a desired current waveform 1320. It should be noted that the voltage measurement circuit 1360 is connected to RWG 1302. RWG 1302 synchronizes its waveform generation process to the voltage waveform 1370 seen at the AC input 306, for example, by using a phase lock loop (PLL) circuit. The desired current 1320 is passed to combiner 1304.

Combiner 1304 subtracts a filtered actual current 1326 from the desired current 1320 to obtain the error signal 1328. Error signal 1328 is passed to GE 1306 where its spectral energy is shaped. GE 1306 performs operations to apply a filtering function to the error signal 1328 to generate a correction signal 1330. The filter function may amplify low-frequency portions of the error signal and attenuate high-frequency portions of the error signal. It should be noted that the control loop is preferably conditionally stable which means that it will not oscillate under normal conditions. However, when overdriven, the control loop may oscillate randomly. In this regard, the GE 1306 amplifies the error signal 528 for low frequency in a way that for the overall loop there is a frequency at which the open loop gain is unity (ULGF) and magnitude (e.g., absolute value) of phase shift is less (e.g., significantly less) than −180°.

The correction signal 1330 is added by combiner 1308 to signal 1370. These operations may stabilize the voltage signal. The corrected input signal 1332 is passed to an input of the PWM modulator 1316 of the CVS 1314. The PWM modulator 1316 is configured to consume a command voltage and battery data in order to determine the right PWM drives signals (duty cycle) for the energy storage module in 100. The energy storage module 100 produces a voltage that is a product of the actual battery voltage and the actual PWM duty cycle.

CCL 1300 is configured to measure the charging current. In this regard, the CCL 1300 is configured to operate in the digital domain. The sampling frequency ƒₛ of CCL 1300 can be selected in accordance with any application. For example, the sampling frequency ƒₛ is selected as 90 kHz. The present solution is not limited to the particulars of this example. The signal is band-limited prior to sampling in order to meet the Nyquist criterion (AAF-aspect). Analog filter of third order may be used to amplify and filter the voltage drop across a corresponding shunt resistor.

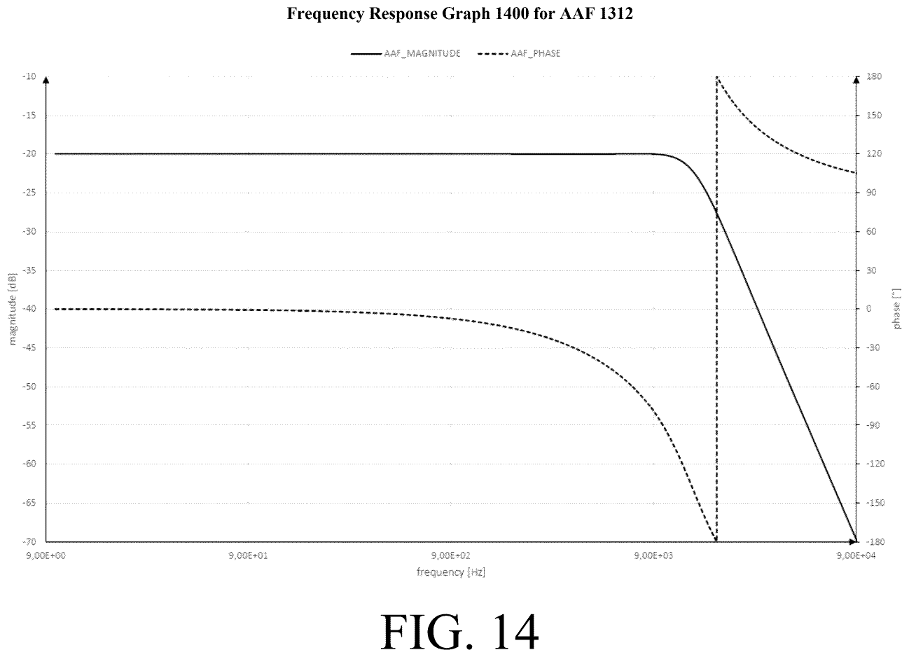

The AAF(s) 1312 of the CCL 1300 may be tuned so that the filter response meets the following requirements: 32 dB damping at the Nyquist frequency of 45 kHz; max. overshoot <20 mdB; phase error at 60 Hz <0.5°; and gain such that 1 digit (of a 12-bit ADC) equals 8.05 mA. An (idealized) frequency response of such filter is shown by graph 1400 of FIG. 14.

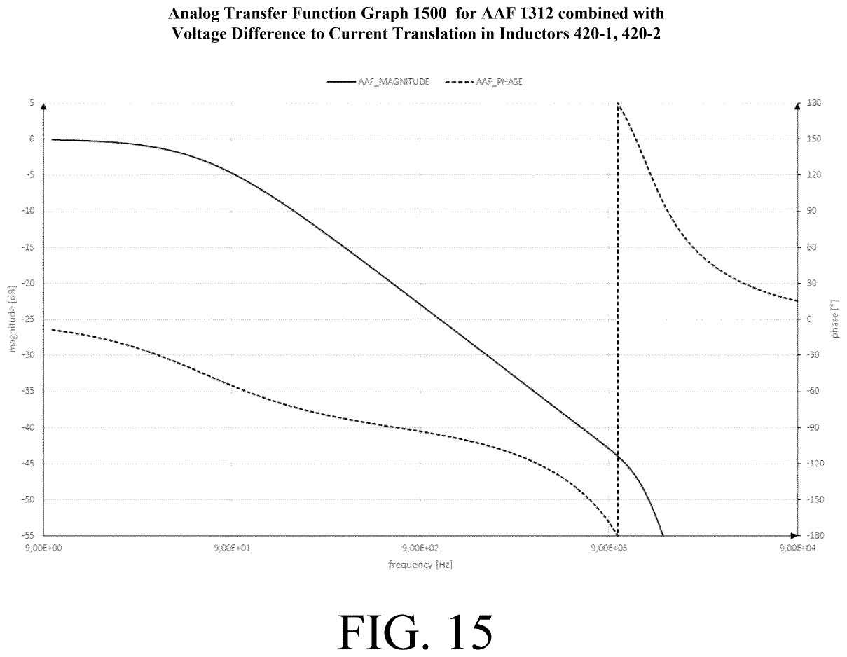

Another component that contributes to the transfer function of the CCL 1300 is the inductor. Its transfer function might be modeled with an inductance of 248 μH and a parasitic series resistance of 100 mΩ. These values are chosen in accordance with the actual components used as inductors 420-1 and 420-2. Graph 1500 of FIG. 15 shows the response of the inductor to a difference of 1V-multiplied with the AAF response from FIG. 14. This scaling step is important for further analysis as the CVS input is also assumed to be scaled in 1 V.

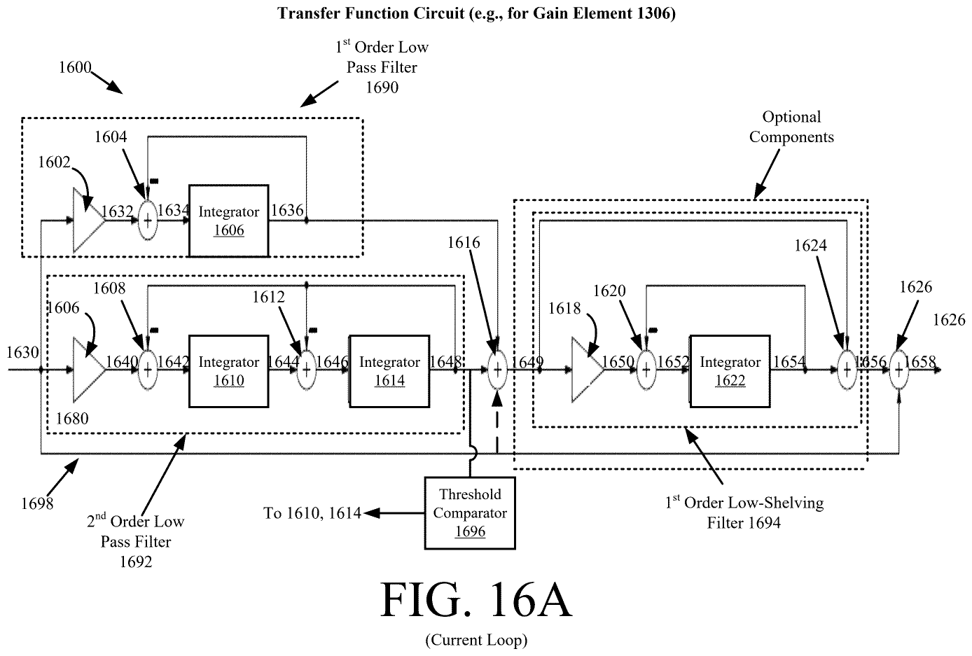

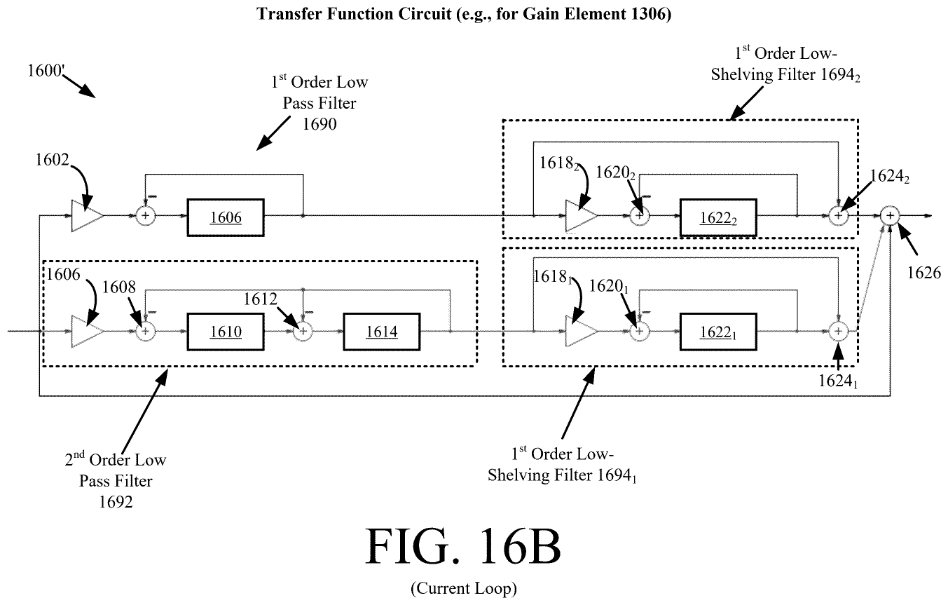

In order to maximize computational efficiency, the transfer function of GE 1306 may comprise a linear combination of digital integrators. FIG. 16A provides a circuit diagram for a transfer function circuit 1600 of a GE (e.g., GE 1306 of FIG. 13). It should be noted that components 1618-1626 are optional components. In the case that these optional components are not provided in the circuit, line 1698 is connected to component 1616 instead of component 1626. Line 1698 can be referred to as a unit gain response connection to provide a gain of a certain value (e.g., 1) between an input and output of the transfer function circuit 1600. In a non-limiting embodiment, the feature 1698 may be a direct connection between the input and output of the transfer function circuit 1600. Thus, more generally, the unit gain feature 1698, via which the error signal 1328 is combined to obtain the third filtered signal 1649 or the output signal 1658, may or may not be a gain of one.

Transfer function circuit 1600 comprises a plurality of low pass filters 1690, 1692, and a first order low-shelving filter 1694. Each of the listed filters may be referred to as a gain component. Filter 1690 comprises a first order low pass filter with operations defined by mathematical equations (4)-(6). First order low pass filter 1690 comprises a combiner 1604 and integrator 1606. The first order low-shelving filter 1694 adds a band limited amplification to the low-pass filter paths (1690, 1992) (e.g., to apply a gain of one). In this regard, the first order low-shelving filter 1694 provides unity response (e.g., neither amplification nor attenuation) for high frequency components, amplification for low frequency components, and first order roll-off (e.g., −20 dB/decade) for intermediary frequency components. Operations of the first order low-shelving filter 1694 are defined by mathematical equation (17).

$$H ( z ) = G \cdot ( ( {k}_{i} / {f}_{s} ) / ( ( {k}_{i} / {f}_{s} ) + 1 - {z}^{- 1} ) ) + 1 \qquad ( 17 )$$

G represents the amplification value of amplifier 1618. First order low-shelving filter 1694 comprises an amplifier 1618, a combiner 1620, 1624 and integrator 1622. Components 1620 and 1622 perform low pass filtering on the signal output from amplifier 1618. Low pass filter 1692 comprises a second order low pass filter 1692 with operations defined by mathematical equations (8)-(16). Second order low pass filter 1692 comprises combiners 1608, 1612 and integrators 1610, 1614.

During operation, an input signal (e.g., error signal 1328 of FIG. 13) is passed to amplifiers 1602 and 1606. Both amplifiers 1602, 1606 perform operations to multiply the input voltage signal by a gain value. For example, in some scenarios, the gain value of amplifier 1602 is selected to be two and the gain value of amplifier 704 is selected to be forty. The present solution is not limited to the particulars of this example.

With regard to the first order low pass filter 1690, low pass filtering of the amplified voltage signal 1632 is performed. In this regard, the amplified voltage signal 1632 is input to combiner 1604. The combiner 1604 subtracts an output voltage signal 1636 of integrator 1606 from the amplified voltage signal 1632 to obtain a combined voltage signal 1634. Voltage signal 1634 is passed to integrator 1606. The integrator 1606 performs operations defined by mathematical equations (1) to obtain an integral of the voltage signal 1634 over a frequency range based on the circuit time constant. Integrator 1606 has a value for parameter kᵢ that is selected in accordance with an application. For example, in some scenarios the value of kᵢ for integrator 712 is selected to be one thousand five hundred. The present solution is not limited to the particulars of this example. The voltage signal 1636 is passed to combiner 1616 which follows the second order low pass filter 1692.

With regard to the second order low pass filter 1692, low pass filtering to amplified voltage signal 1632 is performed. In this regard, the amplified voltage signal 1632 is input to combiner 1608. Combiner 1608 subtracts a feedback signal 1648 from the voltage signal 1632 to obtain combined signal 1642. Combined signal 1642 is passed to an input of integrator 1610. Integrator 1610 performs operations defined by mathematical equation (1) to obtain an integral of the voltage signal 1642 over a frequency range based on the circuit time constant. Integrator 1610 has a value for parameter k_{i,A} that is selected in accordance with an application. For example, in some scenarios, the value of k_{i,A} for integrator 1610 is selected to be one thousand. The present solution is not limited to the particulars of this example. The output voltage signal 1644 of integrator 1610 is passed to a next combiner 1612 of the second order low pass filter 1692. Combiner 1612 subtracts the feedback signal 1648 from voltage signal 1644 of integrator 1610 to obtain a combined voltage signal 1646. Combined voltage signal 1646 is passed to integrator 1614. Integrator 1614 performs operations defined by mathematical equation (1) to obtain an integral of the combined voltage signal 1646 over a frequency range based on the circuit time constant. Integrator 1614 has a value for parameter k_{i,B} that is selected in accordance with an application. For example, in some scenarios, the value of k_{i,B} for integrator 710 is selected to be two hundred. The present solution is not limited to the particulars of this example. The output voltage signal 1648 of integrator 1614 is not only fed back to combiners 1608 and 1612, but is also passed forward to combiner 1616. Combiner 1616 combines signals 1636 and 1648 to produce combined signal 1649. Signal 1649 is passed forwards to amplifier 1618 and combiner 1624 of the first order low-shelving filter 1694.

Amplifier 1618 performs operations to multiply the incoming waveform by a gain value. The gain value can be selected in accordance with an application. For example, the gain value is selected to be ten. The present solution is not limited to the particular of this example. As noted above, first order low-shelving filter 1694 performs low pass filtering with a transfer function. In this regard, voltage signal 1650 is passed to combiner 1620. Combiner 1620 subtracts an output voltage signal 1654 of integrator 1622 from the output voltage signal 1650 of amplifier 1618 to obtain combined voltage signal 1652. Voltage signal 1652 is passed to an input of integrator 1622. Integrator 1622 performs operations defined by mathematical equation (1) to obtain an integral of the combined voltage signal 1654 over a frequency range based on the circuit time constant. Integrator 1622 has a value for parameter kᵢ that is selected in accordance with an application. For example, in some scenarios, the value of kᵢ for integrator 710 is selected to be one hundred. The present solution is not limited to the particulars of this example. The output voltage signal 1654 of integrator 1622 is not only fed back to combiner 1620, but is also passed forward to an input combiner 1624.

Combiner 1624 adds the voltage signal 1649 to the output voltage signal 1654 of the integrator 1622. The output signal 1656 of the combiner 1624 is passed to an input of a next combiner 1626. Combiner 1626 adds the signal 1630 to signal 1656 to generate an output signal of the transfer function circuit 1600. Error signal 1630 can include, but is not limited to, error signal 1328 of FIG. 13.

The transfer function circuit 1600 may also optionally comprise a threshold comparator 1696 connected to the output of integrator 1614. The threshold comparator 1696 is configured to compare the signal 1648 to a threshold value. A result of this comparison operation is provided to integrators 1610 and 1614 for use in controlling operations thereof.

The present solution is not limited to the transfer function architecture shown in FIG. 16A. Another illustrative transfer function architecture is shown in FIG. 16B. Common circuit components are referenced in FIGS. 16A and 16B using the same reference numbers. The difference between circuit 1600 and 1600′ is that circuit 1600′ has two optional first order low-shelving filters 16941, 16942. Each set of components 16181, 16201, 16221, 16241 and 161812, 16202, 16222, 16242 may be referred to as a first order low-shelving filter. The circuit of FIG. 16A has a common first order low-shelving filter 1694 for both the top and bottom signal paths, which provides improved computational costs, complexity and processing power. This simplification is possible if first order low-shelving filter 16941 exactly equals first order low-shelving filter 16942.

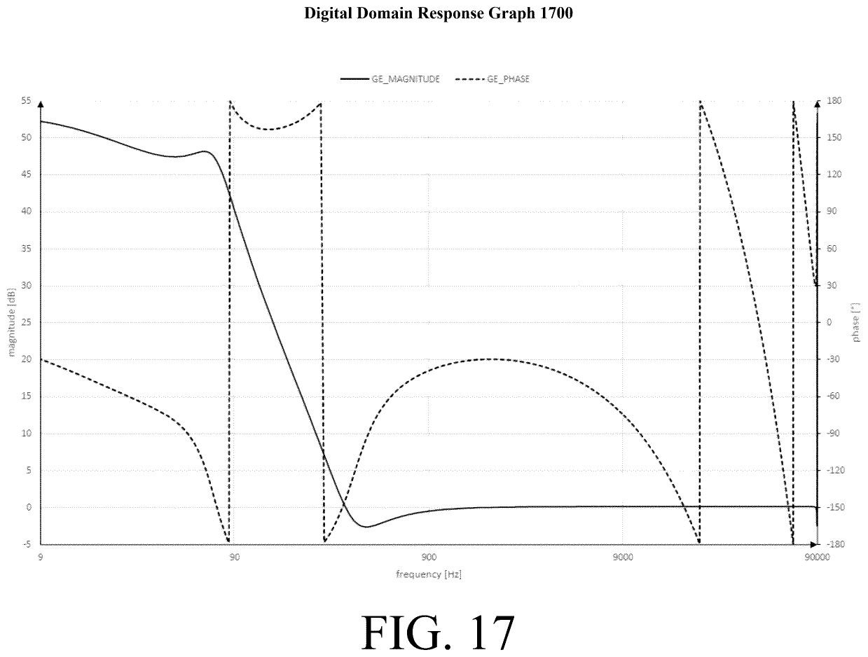

By further taking into account two 1/90 kHz unit delays which result from analog-to-digital conversion (ADC), direct memory access (DMA) and PWM operation, a response of the digital domain parts as shown in graph 1700 of FIG. 17 is obtained.

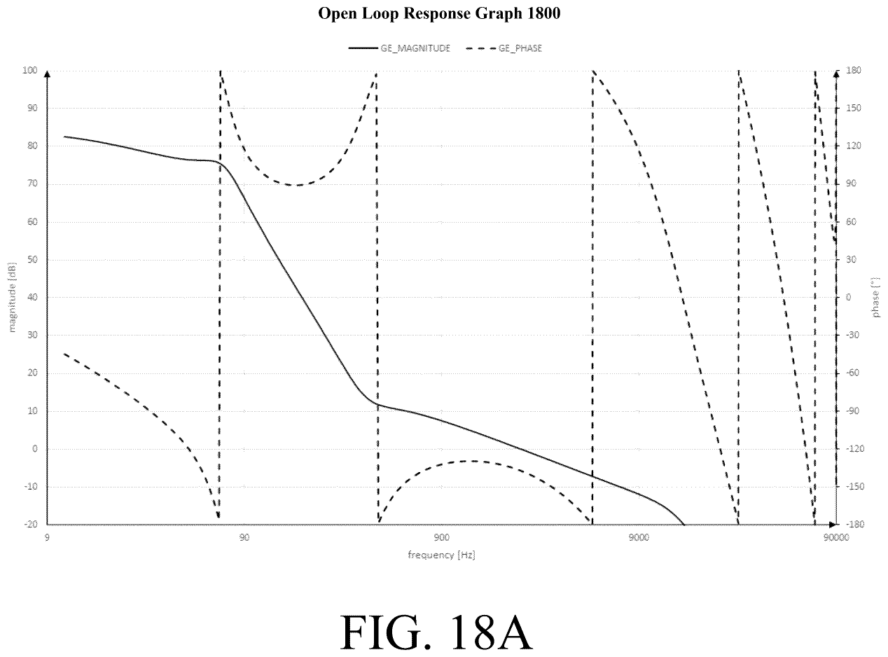

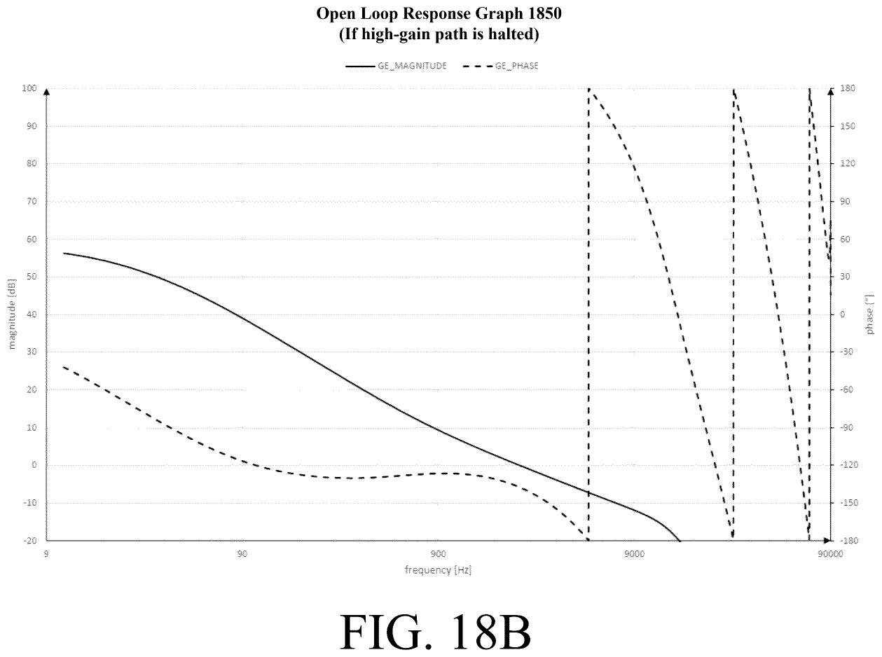

These two transfer functions of FIG. 15 and FIG. 17 may be multiplied to obtain the overall open loop response shown by graph 1800 of FIG. 18A—from which it is possible to conclude whether the closed loop will be stable or not. The depicted transfer function further includes a multiplicative scaling factor (gain) that is present in the device due to current-to-voltage unit conversion. As can be seen in FIG. 18, ULGF is around 2 kHz. A phase margin is around 55°. A gain margin is around 10 dB.

In some scenarios, part 1608 of transfer function circuit 1600 may be halted. The remaining open loop transfer function can be seen in graph 1850 of FIG. 18B.

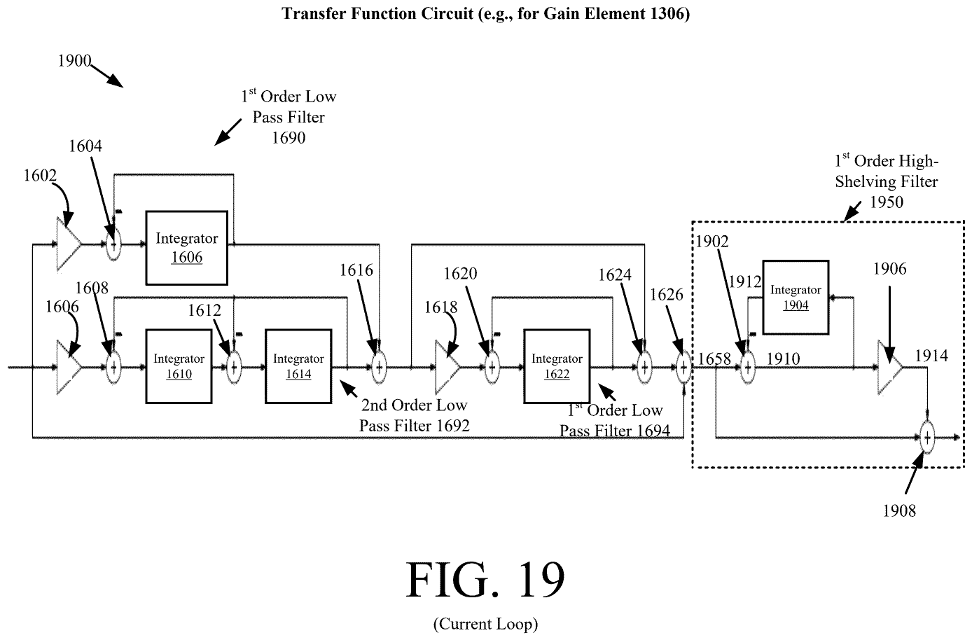

FIG. 19 provides a circuit diagram of another transfer function circuit 1900 for a GE (e.g., GE 1306 of FIG. 13). Transfer function circuit 1900 comprises a linear combination of integrators. Transfer function circuit 1900 was generated by combining the circuit of FIG. 16A with a first order high-pass filter 1902, 1904 and a gain element 1906. The gain element 1906 may alternatively reside prior to combiner 1902 in other scenarios. The direct path around the first order high-pass filter and combiner 1908 gives a first order high-shelving filter 1950. The first order high-shelving filter 1950 comprises a first order high-pass filter 1902, 1904, gain element 1906 and direct path plus combiner 1908. First order high-shelving filter 1950 is configured to perform high pass filtering with a transfer function. In this regard, first order high-shelving filter 1950 comprises combiner 1902 and integrator 1904 to implement the high pass filtering. High pass filtering operations can be defined by mathematical equations (18)-(19).

$$H = Y / X = 1 / ( 1 + A ) \qquad ( 18 )$$

$$A = A ( z ) = ( {k}_{i} / {f}_{s} ) ( 1 / ( 1 - {z}^{- 1} ) ) \qquad ( 19 )$$

Setting mathematical equation (19) into mathematical equation (18) provides mathematical equation (20).

$$H ( z ) = 1 / ( ( {k}_{i} / {f}_{s} ) \cdot ( 1 / ( 1 - {z}^{- 1} ) ) + 1 ) \qquad ( 20 )$$

The high pass filter may be modified to provide a high-shelving filter as defined by mathematical equation (21).

$$H ( z ) = ( G / ( ( {k}_{i} / {f}_{s} ) \cdot ( 1 / ( 1 - {z}^{- 1} ) ) + 1 ) ) + 1 \qquad ( 21 )$$

G represents the amplification value of amplifier 1906. In sum, the first order high-shelving filter 1950 provides unity response (e.g., neither amplification nor attenuation) for low frequency components, a slope of +20 db/decade for intermediary frequency components, and amplification of high frequency components.

During operations, the output signal 1658 of combiner 1626 is passed forward to the first order high-shelving filter 1950. The first order high-shelving filter 1950 high pass filters signal 1658 with a transfer function. In this regard, signal 1650 is combined by combiner 1902 with the output signal 1912 of integrator 1904. The resulting signal 1910 is passed to the input of integrator 1904 and an input of an amplifier 1906. Amplifier 1906 has a gain value selected in accordance with an application. For example, the gain value for amplifier 1906 is selected to be two. The present solution is not limited in this regard. The output signal 1914 of amplifier 1906 is combined with signal 1658 by combiner 1908 to produce the output signal of the transfer function circuit 1900.

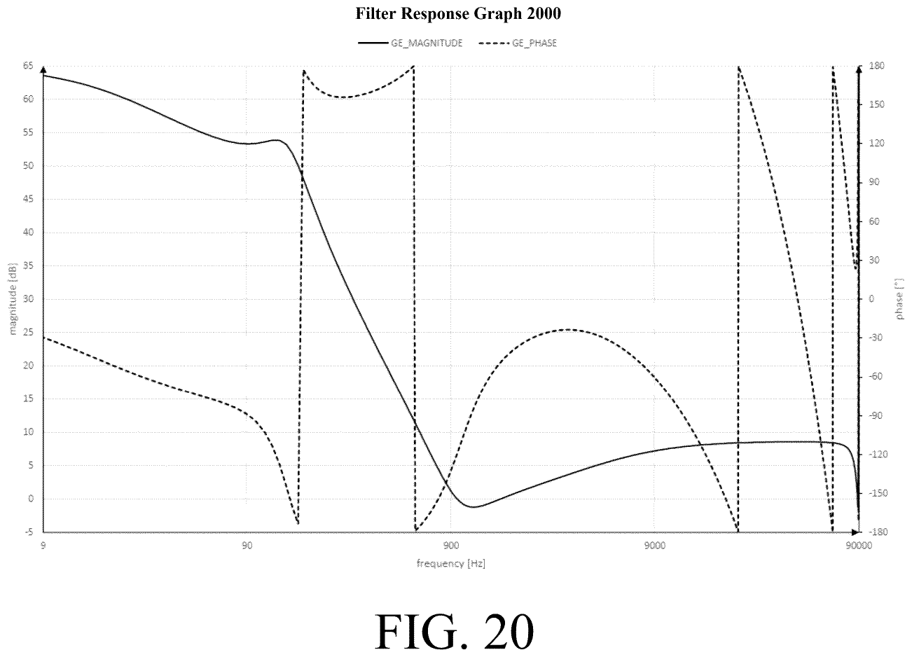

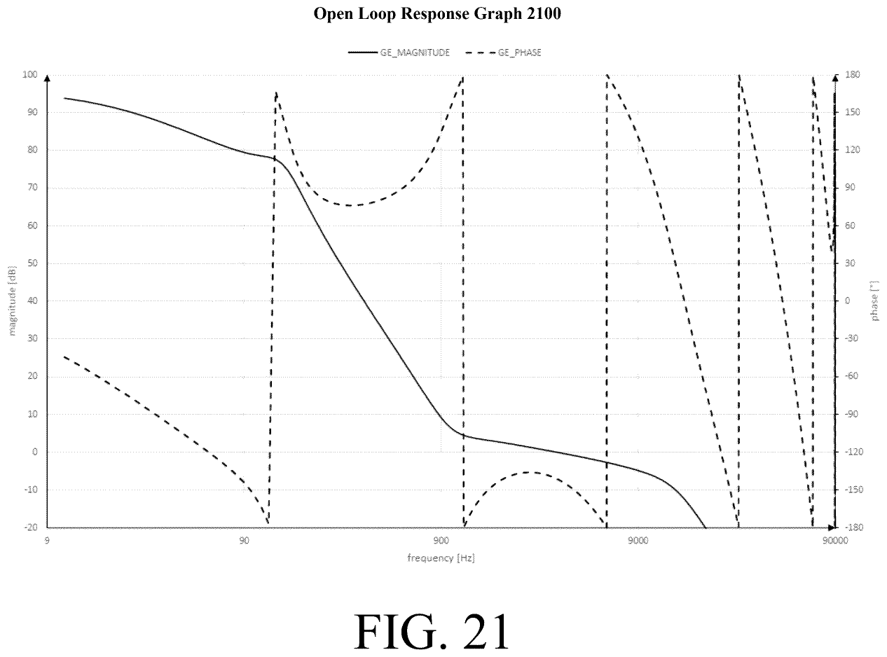

The filter response of the transfer function circuit 1900 is shown by graph 2000 of FIG. 20, while graph 2100 of FIG. 21 shows the combined open loop response of the overall loop 1300 with the transfer function circuit 1900 in 1306. Graph 2100 shows an improved loop gain below 1 kHz (while keeping phase margin and shifting ULGF to approx. 3 kHz) (compared to the response shown in FIG. 18A).

Model based control-Voltage loop. As already discussed in relation to FIG. 5, the response of CVS 514 comprises (i) components or features that are unknown (e.g., hard to calculate and/or predict) and (ii) components or features that are well known (e.g., well predictable). Components/features (i) may be mitigated by the control loop. The components/features (i) may include, but are not limited to, a voltage drop over parasitic resistance. Components/features (ii) can include, but are not limited to, the 1/90 kHz unit delay caused by the operation of the PWM algorithm that consumes the command voltage and pre-calculates module order and duty cycle in the current 1/90 kHz cycle in order to apply the actual waveforms in the subsequent cycle.

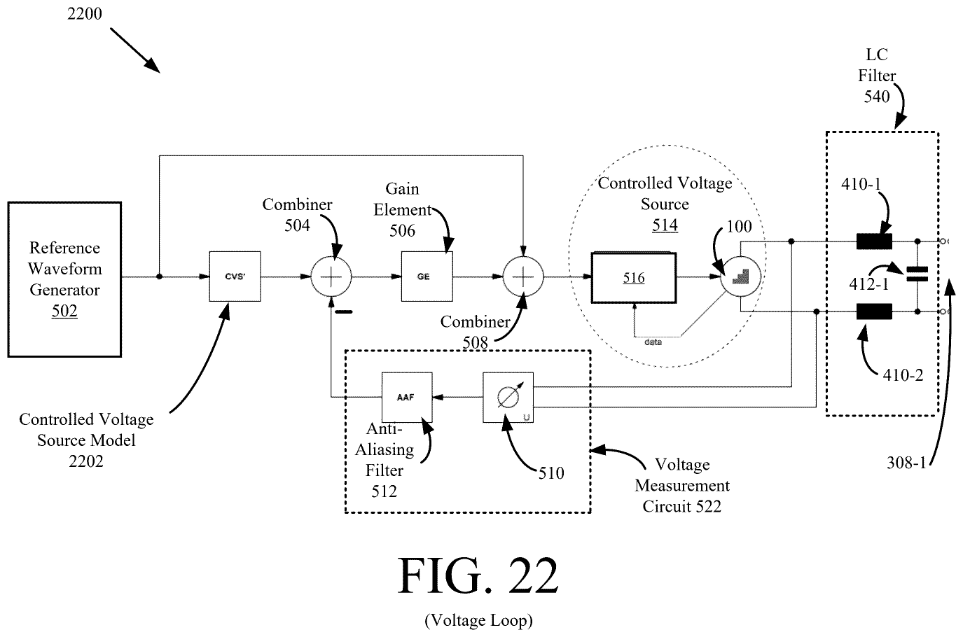

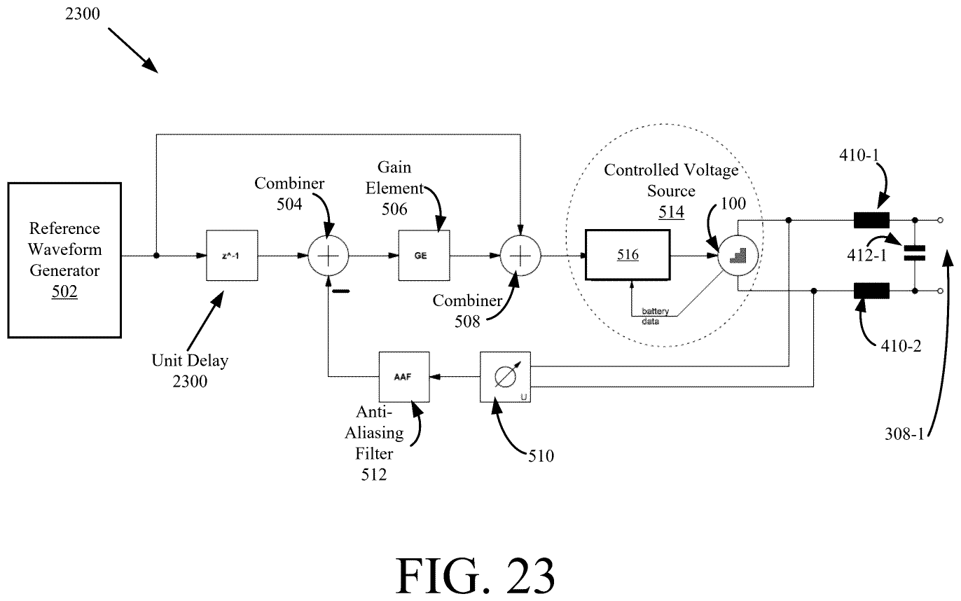

In order to mitigate components/features (ii) the circuit may be modified by adding a controlled voltage source model 2202 between the RWG 502 and combiner 504 as shown in FIG. 22. The controlled voltage source model 502 comprises a model of the invariant parts (ii). One possible function of the controlled voltage source model 502 may be a unit delay 2300 as shown in FIG. 23. The unit delay 2300 may be configured to delay the signal by one sample. The present solution is not limited in this regard. The controlled voltage source model 2202 pre-distorts or pre-filters the input to combiner 504 in a way that is very close to the way CVS 514 reacts to an input signal (under no-load condition). Like this, the error term is minimized which helps to keep the GE far from entering halted operation.

Model based control-Current loop. An estimate of the amount of voltage difference to go from a first sample of desired current to the subsequent sample may be obtained by assuming a proper value for inductance and resistance in the circuit. For example, in one scenario, an assumption is made that inductance is 248 pH and a resistance is 100 mΩ. The voltage difference Au to go from one current value i[k] to i[k+1] may be calculated using the following mathematical equation (22):

$${Δ}_{u} ( \frac{L}{Δ t} + R ) \cdot ( i [ k + 1 ] - i [ k ] ) = ( ( 248 μH \cdot 90 kHz ) + 100 m Ω ) \cdot ( i [ k + 1 ] - i [ k ] ) = 22.42 \frac{V}{A} ( i [ k + 1 ] - i [ k ] ) . \qquad ( 22 )$$

It shall be appreciated that the values (e.g., component values and/or frequency value) shown in herein used examples (e.g., above equation) are non-limiting to the scope and generality of the present teachings.

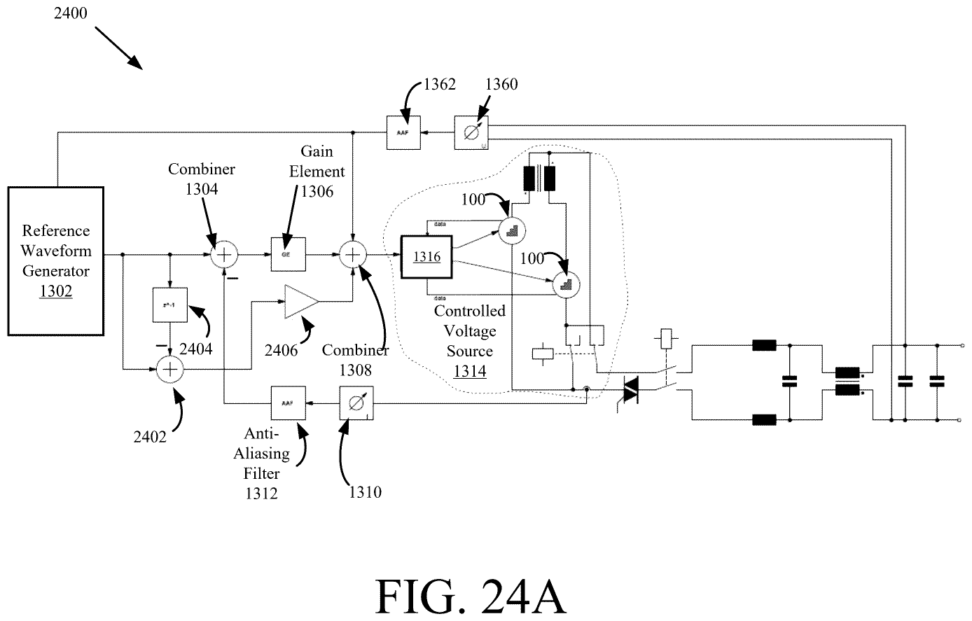

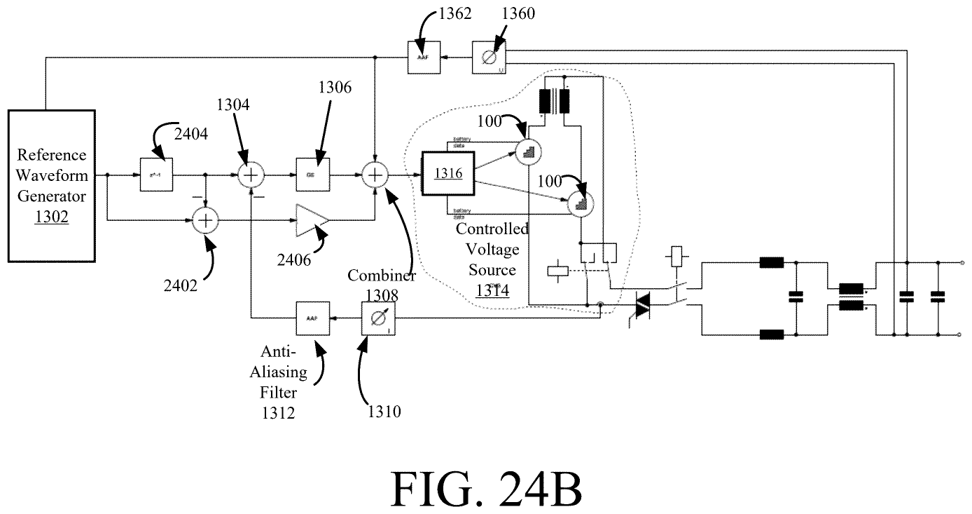

FIG. 24A provides an illustration of a circuit 2402, 2404, 2406 configured to compute Au based on two subsequent values of desired current. This difference (Δu) is input to combiner 1308 thereby contributed additively to the signal provided to PWM modulator 1316.

FIG. 24B provides an illustration of a circuit that further takes the input to combiner 1304 from the output of unit delay 2404 which was introduced to calculate (i[k+1]−i[k]) with FIG. 24A. Again, there is a unit delay 2406 inside CVS which causes the voltage across the inductors 410-1, 410-2 applied during one 1/90 kHz PWM cycle being correspondent to the desired current calculated one cycle before. This might be taken into account by pre-filtering the input to the control loop as showed for the voltage loop already. Like this, the error term is minimized which helps to keep the GE far from entering halted operation.

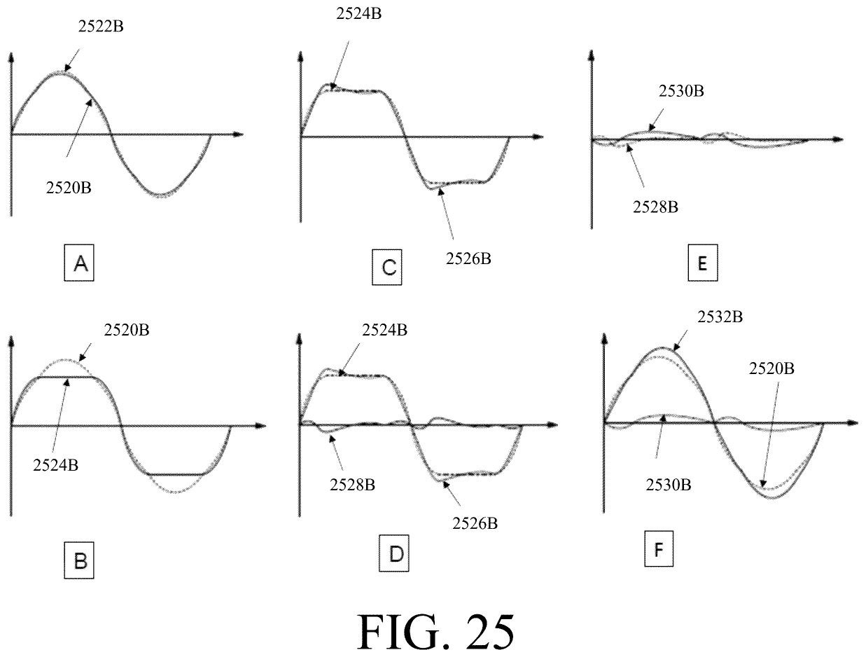

FIG. 25 provides graphs showing illustrative waveforms at different points in the current loop 1300. In FIGS. 25A and 25B, in the plot taken at node A of electrical system 1300, waveform 2520B may be a voltage waveform that is produced based on a voltage measured by voltage measurement circuit 1360 at input port circuit 1390 (e.g., a voltage across capacitor 414A). Waveform 2522B is a pure sine wave shown in dotted line for comparison. As further shown in FIGS. 25A and 25B, in the plot taken at position B of electrical system 1300, reference waveform 2524B may be provided as an output of waveform generator 1302. Reference waveform 2524B may act as a reference waveform that is in phase with waveform 2520B shown in dotted line for comparison. Reference waveform 2524B may act as a reference waveform to provide a guide as to how a charging current for charging ESMs should ideally look.

As further shown in FIGS. 25A and 25B, in the plot taken at position C of electrical system 1300, waveform 2526B is a waveform of the actual charging current applied to ESMs. Reference waveform 2524B is shown in dotted line for comparison. As further shown in FIGS. 25A and 25B, in the plot taken at position D of electrical system 1300, waveform 2528B is a waveform of an error signal that is based on a deviation between waveform 2526B (shown in dotted line) and waveform 2524B (shown in dotted line).

As further shown in FIGS. 25A and 25B, in the plot taken at position E of electrical system 1300, waveform 2530B is a waveform of the output of gain element 1306. In some non-limiting embodiments, the output of gain element 1306 may be based on a transfer function (as a non-limiting example, convolution operation) of waveform 2528B (shown in dotted line) and an impulse response of gain element 1306. As further shown in FIGS. 25A and 25B, in the plot taken at position F of electrical system 1300, waveform 2532B is a waveform of a desired output voltage at an inverter circuit (e.g., inverter circuit 114 or power module 404) of electrical system 1300. In some non-limiting embodiments, waveform 2532B may be provided by adding waveform 2520B and waveform 2530B.

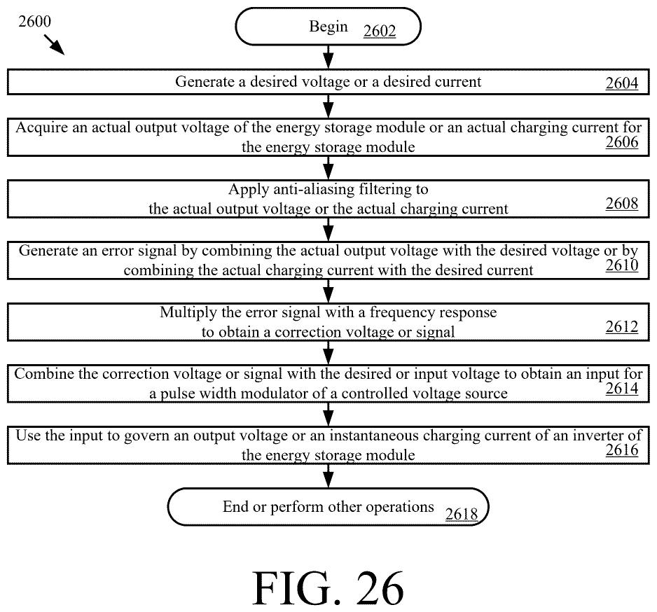

FIG. 26 provides a flow diagram of an illustrative method 2600 for operating a circuit (e.g., circuit 500 of FIG. 5, 700 of FIG. 7, 1000 of FIG. 10, 1300 of FIG. 13, 1600 of FIG. 16A, 1600′ of FIG. 16B, 1900 of FIG. 19, 2200 of FIG. 22, 2300 of FIG. 23, and/or 2400 of FIG. 24) with an energy storage module (e.g., energy storage module 100 of FIG. 1). Method 2600 begins with 2602 and continues with 2604 where a desired voltage (e.g., desired voltage 520 of FIG. 5) or a desired current (e.g., desired current 1320 of FIG. 13) is generated. In next block 2606, an actual output voltage (e.g., actual output voltage 524 of FIG. 5) or an actual charging current (e.g., actual charging current 1324 of FIG. 13) for the energy storage module is acquired. Anti-aliasing filtering may be applied to the actual output voltage or the actual charging current in block 2608.

An error signal (e.g., error signal 528 of FIG. 5 or 1328 of FIG. 13) is generated in block 2610. The error signal may be generated by combining the actual output voltage with the desired voltage or by combining the actual charging current with the desired current. For example, the actual output voltage may be subtracted from the desired voltage or the actual charging current may be subtracted from the desired current. The error signal is multiplied with a frequency response in block 2612 to obtain a correction voltage or signal (e.g., correction voltage or signal 530 of FIG. 5 or 1330 of FIG. 13). The multiplication operation of block 2612 may be achieved using a linear combination of digital integrators implementing a transfer function from which the frequency response is derived.

In some scenarios, the multiplication operation of block 2612 involves: applying second order low pass filtering to the error signal to obtain a first filtered signal (e.g., signal 730 of FIG. 7); applying first order low pass filtering to the first filtered signal to obtain a second filtered signal (e.g., signal 744 of FIG. 7); combining the first filtered signal with the second filtered signal to obtain a third filtered signal (e.g., signal 746 of FIG. 7); applying first order low pass filtering to the error signal to obtain a fourth filtered signal (e.g., signal 752 of FIG. 7); and combing the error signal, the third filtered signal, and/or the fourth filtered signal. The error signal may be amplified using a first gain value prior to applying the second order low pass filtering thereto, and/or amplified using a lower second gain value prior to applying the first order low pass filtering thereto. The second filtered signal may be amplified prior to applying the first order low pass filtering thereto. In some scenarios, block 2612 may also comprise comparing the third filtered signal output from a high-gain path (e.g., high-gain path 750 of FIG. 7) with a threshold value, and providing a result of this comparing to integrators (e.g., integrators 710, 716 and 722 of FIG. 7) of a second order low pass filter (e.g., filter 782 of FIG. 7) and a first order low-shelving filter (e.g., filter 784 of FIG. 7) of the high-gain path.

In those or other scenarios, the multiplication operations of block 2612 involve: applying first order low pass filtering to the error signal to obtain a first filtered signal (e.g., signal 1636 of FIG. 16A); applying a second order low pass filtering to the error signal to obtain a second filtered signal (e.g., signal 1648 of FIG. 16A); combining the first and second filtered signals to obtain a third filtered signal (e.g., signal 1649 of FIG. 16A); applying first order low pass filtering to the third filtered signal to obtain a fourth filtered signal (e.g., signal 1654 of FIG. 16A); combining the third and fourth filtered signals to obtain a fifth filtered signal (e.g., signal 1656 of FIG. 16A); combing the error signal with the fifth filtered signal to obtain a combined signal (e.g., signal 1658 of FIG. 16A); applying first order high pass filtering to the combined signal to obtain a sixth filtered signal (e.g., 1910 of FIG. 19); and/or combining the sixth filtered signal with the combined signal. The error signal may be amplified using a first gain value prior to applying the second order low pass filtering thereto, and/or amplified using a lower second gain value prior to applying the first order low pass filtering thereto. The third filtered signal may be amplified prior to applying the first order low pass filtering thereto. In some scenarios, block 2612 may also comprise comparing the second filtered signal with a threshold value, and providing a result of the comparing to integrators (e.g., integrators 1610 and 1614 of FIG. 16A) of a second order low pass filter (e.g., filter 1692 of FIG. 16A).

Referring back to FIG. 26, the correction voltage or signal (e.g., correction voltage or signal 530 of FIG. 5 or 1330 of FIG. 13) is combined (e.g., in block 508 of FIG. 5 or block 1308 of FIG. 13) with the desired voltage (e.g., desired voltage 520 of FIG. 5) or a measurement of the input voltage (e.g., signal 1370 of FIG. 13) in block 2614. The operations of block 2614 produce an input (e.g., command voltage 532 of FIG. 5 or 1332 of FIG. 13) for a PWM modulator (e.g., PWM modulator 516 of FIG. 5 or 1316 of FIG. 13) of a CVS (e.g., CVS 514 of FIG. 5 or 1314 of FIG. 13).

In 2616, the input is used to govern an output voltage or an instantaneous charging current of an inverter (e.g., transistor active bridge circuit 144 of FIG. 1E) of the energy storage module. For example, the input is used to determine the percentage of a cycle that the energy storage module is be ON or connected to a load, and controlling the energy storage module to be ON for the determined percentage of the cycle. Subsequently, method 2600 continues to 2618 where it ends or other operations are performed.

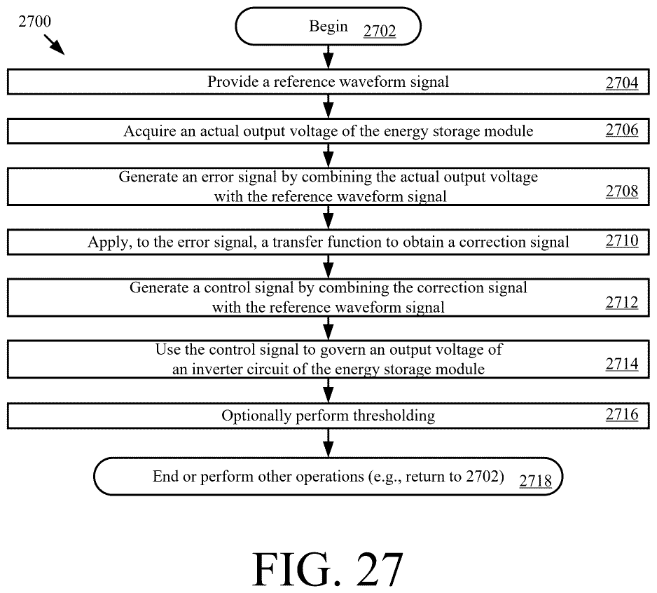

FIG. 27 provides a flow diagram of another illustrative method 2700 for operating a circuit (e.g., circuit 500 of FIG. 5) with an energy storage module (e.g., energy storage module 100 of FIG. 1). The circuit performs the operations of blocks 2702-2718. The operations can be performed in the same or different order than that shown. Also, method 2700 can include more or less operations, steps or blocks than that shown.

Method 2700 begins with 2702 and continues with 2704 where a reference waveform signal (e.g., reference waveform signal 520 of FIG. 5) is provided. Next in 2706, an actual output voltage (e.g., actual output voltage 534 of FIG. 5) of the energy storage module is acquired. An error signal (e.g., error signal 528 of FIG. 5) is generated in block 2708 by combining the actual output voltage with the reference waveform signal (520). This combining can involve subtracting the actual output voltage from the reference waveform signal. Block 2708 may also involve applying anti-aliasing filtering to the actual output voltage prior to generating the error signal.

A transfer function is applied to the error signal in block 2710 to obtain a correction signal (e.g., correction signal 530 of FIG. 5). The transfer function may be at least partially applied using a linear combination of digital integrators (e.g., integrators 710, 716, 722 of FIG. 7). In some scenarios, the operations of block 2710 involve: applying second order low pass filtering (e.g., at filter 782 of FIG. 7) to the error signal to obtain a first filtered signal (e.g., signal 730 of FIG. 7); applying first order low-shelving filtering (e.g., at filter 784 of FIG. 7) to the first filtered signal to obtain a second filtered signal (e.g., signal 744 of FIG. 7); combining the first filtered signal with the second filtered signal to obtain a third filtered signal (e.g., signal 746 of FIG. 7); applying first order low pass filtering (e.g., at filter 780 of FIG. 7) to the error signal to obtain a fourth filtered signal (e.g., signal 752 of FIG. 7); combing the third and fourth filtered signals; and/or combining (e.g., at combiner 726 of FIG. 7) the error signal with the third and fourth filtered signals. The error signal may be (i) amplified (e.g., at amplifier 702 of FIG. 7) using a first low-frequency DC gain value prior to applying the second order low pass filtering thereto and/or (ii) amplified (e.g., at amplifier 704 of FIG. 7) using a lower second DC gain value prior to applying the first order low pass filtering thereto. The first filtered signal may be amplified (e.g., at amplifier 718 of FIG. 7) prior to applying the first order low pass filtering thereto.

A control signal (e.g., control signal 532 of FIG. 5) is generated in block 2712 by combining the correction signal with the reference waveform signal. The control signal is used in block 2714 to govern an output voltage of an inverter circuit (e.g., transistor active bridge circuit 144 of FIG. 1) of the energy storage module.

Method 2700 may include optional block 2716 where thresholding may be performed. The thresholding operation can involve: comparing (e.g., at comparator 790 of FIG. 7) the third filtered signal output from a high-gain path (e.g., high-gain path 750 of FIG. 7) with a threshold value; and providing a result of the comparing to integrators (e.g., integrators 710, 716, 722 of FIG. 7) of a second order low pass filter (e.g., filter 782 of FIG. 7) and a first order low-shelving filter of the high-gain path (e.g., filter 784 of FIG. 7). Upon completing the operations of block 2714 and/or 2716, method 2700 continues with 2719 where it ends or other operations are performed (e.g., return to 2702).

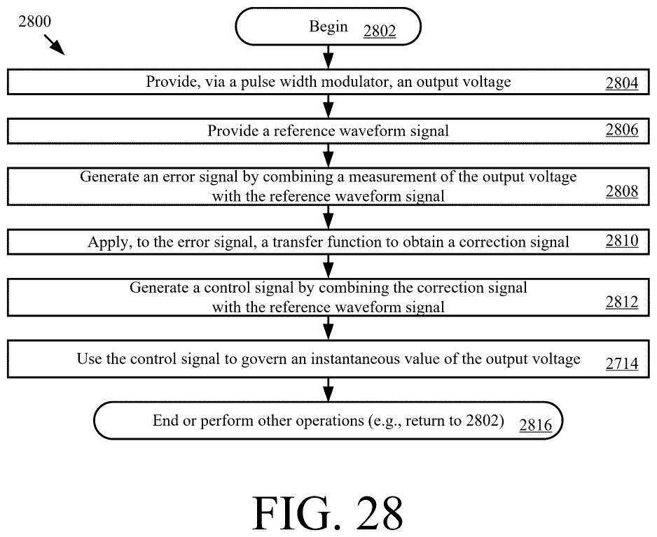

FIG. 28 provides a flow diagram of another illustrative method 2800 for operating a circuit (e.g., circuit 500 of FIG. 5) with an energy storage module (e.g., energy storage module 100 of FIG. 1). The circuit performs the operations of blocks 2802-2816. The operations can be performed in the same or different order than that shown. Also, method 2800 can include more or less operations, steps or blocks than that shown.

Method 2800 begins with 2802 and continues with 2804 where the circuit provides, via a pulse width modulator (e.g., pulse width modulator 516 of FIG. 4), an output voltage (e.g., output voltage 524 of FIG. 5) from the energy storage module. A reference waveform signal (e.g., reference waveform signal 520 of FIG. 5) is provided in 2806. An error signal (e.g., error signal 528 of FIG. 5) is generated in 2808 by combining a measurement of the output voltage with the reference waveform signal. In 2810, a transfer function is applied to the error signal to obtain a correction signal (e.g., signal 530 of FIG. 5). The transfer function can include, but is not limited to: a first gain component (e.g., second order low pass filter 782 of FIG. 7), a second gain component (e.g., first order low pass filter 780 of FIG. 7) acting parallelly to the first gain component. The first gain component may have a second-order low-pass response with a first low-frequency DC gain value. The second gain component may have a first-order low-pass response with a second low-frequency DC gain value. The first low-frequency DC gain value is higher than the second low-frequency DC gain value.

A control signal (e.g., control signal 532 of FIG. 5) is generated by combining the correction signal with the reference waveform signal, as shown by block 2812. In 2814, the control signal is used to govern an instantaneous value of the output voltage. Subsequently, method 2800 continues to 2816 where it ends or other operations are performed.

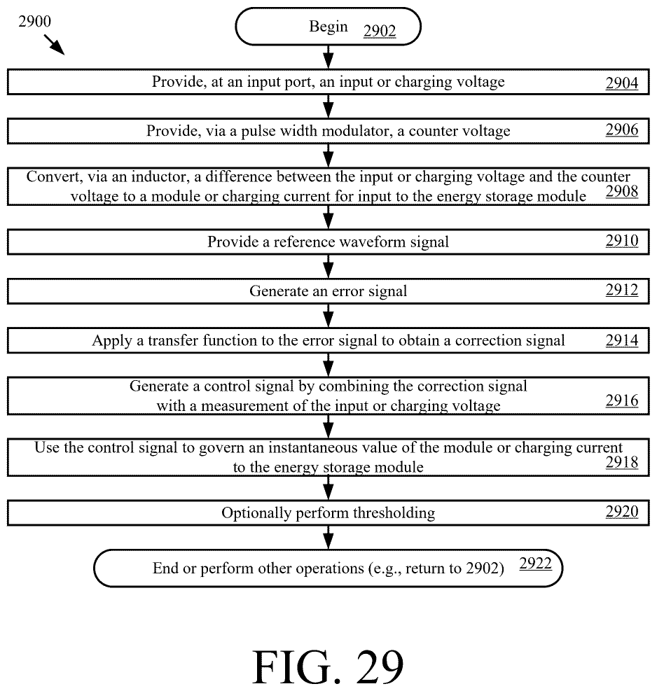

FIG. 29 provides a flow diagram of another illustrative method 2900 for operating a circuit (e.g., circuit 1300 of FIG. 13) with an energy storage module (e.g., energy storage module 100 of FIG. 1). The circuit performs the operations of blocks 2902-2922. The operations can be performed in the same or different order than that shown. Also, method 2900 can include more or less operations, steps or blocks than that shown.

Method 2900 begins with 2902 and continues with 2904 where an input voltage or a charging voltage is provided at an input port (e.g., input port 306 of FIG. 3). A counter voltage is provided in block 2906 via a pulse width modulator (e.g., pulse width modulator 1316 of FIG. 13). In 2908, operations are performed by the circuit to convert, via an inductor (e.g., inductor(s) 420-1, 420-2 of FIG. 4), a difference between the input or charging voltage and the counter voltage to a module or charging current (e.g., charging current 1324 of FIG. 13) for input to, charging of, or discharging from the energy storage module.

A reference waveform signal (e.g., reference waveform signal 1320 of FIG. 13) is provided in 2910. An error signal (e.g., error signal 1328 of FIG. 13) is generated in block 2912 by combining a measurement of the module or charging current with the reference waveform signal. Block 2912 may also involve applying anti-aliasing filtering to the module or charging current prior to generating the error signal. The error signal may be generated by subtracting the module or charging current from the reference waveform signal.

A transfer is applied to the error signal in block 2914 to obtain a correction signal (e.g., signal 1330 of FIG. 13). The transfer function can include, but is not limited to: a first gain component (e.g., second order low pass filter 1692 of FIG. 16A), a second gain component (e.g., first order low pass filter 1690 of FIG. 16A) acting parallelly to the first gain component, and a unit gain response (e.g., link 1698 of FIG. 16A) providing a gain between an input and output of the transfer function. The first low-frequency DC gain value is higher than the second low-frequency DC gain value. The second low-frequency DC gain value may be higher than the unit gain. The unit gain may be lower than the second low-frequency DC gain value. The first gain component (1692) may include, but is not limited to, a linear combination of digital integrators (e.g., integrator 1610, 1614 of FIG. 16A).

In some scenarios, the application of the transfer function comprises: applying first order low pass filtering (e.g., at filter 1609 of FIG. 16A) to the error signal to obtain a first filtered signal (e.g., signal 1636 of FIG. 16A); applying a second order low pass filtering (e.g., at filter 1692 of FIG. 16A) to the error signal to obtain a second filtered signal (e.g., signal 1648 of FIG. 16A); and combining the first filter signal, the second filtered signal and/or the error signal to obtain a third filtered signal (e.g., signal 1649 of FIG. 16A). The error signal may be (i) amplified (e.g., at amplifier 1606 of FIG. 16A) using the first low frequency DC gain value prior to applying the second order low pass filtering thereto and/or (ii) amplified (e.g., at amplifier 1602 of FIG. 15) using the second low frequency DC gain value prior to applying the first order low pass filtering thereto.

In those or other scenarios, the application of the transform function comprises: applying first order low-shelving operations (e.g., operations of filter 1694 of FIG. 16A) to the third filtered signal to obtain a fourth filtered signal (e.g., signal 1654 of FIG. 16A); combining the third and fourth filtered signals to obtain a fifth filtered signal (e.g., signal 1656 of FIG. 16A); and combining the error signal with the fifth filtered signal to obtain a combined signal (e.g., signal 1658 of FIG. 16A). The third filtered signal may be amplified (e.g., at amplifier 1618 of FIG. 16A) prior to applying the first order low pass filtering thereto.

In those or other scenarios, the application of the transfer function comprises: applying first order high-shelving operations (e.g., operations of filter 1950 of FIG. 19) to the combined signal to obtain a sixth filtered signal (e.g., signal 1910 of FIG. 19); and combining (e.g., at combiner 1908 of FIG. 19) the sixth filtered signal with the combined signal (e.g., signal 1658 of FIGS. 16A and 19).

A control signal (e.g., control signal 1332 of FIG. 13) is generated in block 2916 by combining the correction signal with a measurement of the input or charging voltage. The control signal is used in 2918 to govern an instantaneous value of the module or charging current for charging or discharging the energy storage module.

Method 2900 may optionally include block 2920 where thresholding may be performed. The thresholding may involve: comparing the second filtered signal with a threshold value; and providing a result of said comparing to integrators (e.g., integrators 1610, 1614 of FIG. 16A) of a second order low pass filter (e.g., filter 1692 of FIG. 16A). Subsequently, method 2900 continues with 2922 where it ends or other operations are performed (e.g., return to 2902).

Thus, there are herein disclosed systems, methods, and software products for operating circuit with energy storage module (ESM). The methods may comprise: providing, at input port, an input voltage (IV); providing, via PWM, counter voltage (CV2); converting, via inductor, a difference between IV and CV2 to module current (MC) which charges or discharges ESM; providing reference waveform signal (RWS); generating error signal (ES) by combining MC measurement with RWS; applying, to ES, a transfer function (TF) to obtain correction signal (CS1); generating control signal (CS2) by combining CS1 with IV measurement; and using CS2 to govern MC's instantaneous value. TF may comprise: first gain component (FGC) having a higher than first-order low-pass response with a first corner frequency (CF), and a first low-frequency (DC) gain value; a second gain component acting parallelly to FGC and having a second low-frequency (DC) gain value; and a unit gain response providing a gain between TF's input and output.

Although the present solution has been illustrated and described with respect to one or more implementations, equivalent alterations and modifications will occur to others skilled in the art upon the reading and understanding of this specification and the annexed drawings. In addition, while a particular feature of the present solution may have been disclosed with respect to only one of several implementations, such feature may be combined with one or more other features of the other implementations as may be desired and advantageous for any given or particular application. Thus, the breadth and scope of the present solution should not be limited by any of the above described scenarios. Rather, the scope of the present solution should be defined in accordance with the following claims and their equivalents.

Without excluding further possible embodiments, certain example embodiments are summarized in the following clauses:

Clause 1: A method (2900) of operating a circuit (1300) with an energy storage module (100), the method comprising: providing, at an input port (306), an input voltage; providing, via a pulse width modulator (1316), a counter voltage; converting, via an inductor (420-1, 420-2), a difference between the input voltage and the counter voltage to a module current (1324) which charges or discharges the energy storage module (100); providing a reference waveform signal (1320); generating an error signal (1328) by combining a measurement of the module current (1324) with the reference waveform signal (1320); applying, to the error signal (1328), a transfer function to obtain a correction signal; generating a control signal (1332) by combining the correction signal (1330) with a measurement of the input voltage (1370); and using the control signal (1332) to govern an instantaneous value of the module current (1324) to the energy storage module (100). The transfer function comprises: a first gain component (1692), wherein the first gain component (1692) has a higher than first-order low-pass response with a first low-frequency gain value (e.g., DC gain value); a second gain component (1690) acting parallelly to the first gain component (1692), wherein the second gain component (1690) has a second low-frequency gain value (e.g., DC gain value); and a unit gain response (1698) providing a gain between an input and output of the transfer function. The first low-frequency (e.g., DC) gain value is higher than the second low-frequency (e.g., DC) gain value.

Clause 2: The method of clause 1, wherein the first gain component (1692) (e.g., the response thereof) has a first corner frequency, and second gain component (1690) has a low-pass response with a second corner frequency higher than the first corner frequency.

Clause 3: The method of any of the preceding clauses, wherein the first low-frequency (or DC) gain value is higher than the second low-frequency (e.g., DC) gain value, and the unit gain is lower than the second low-frequency (e.g., DC) gain value.

Clause 4: The method of any of the preceding clauses, further comprising applying anti-aliasing filtering to the module current (1324) prior to generating the error signal (1328).

Clause 5: The method of any of the preceding clauses, wherein said generating the error signal (1328) comprises subtracting the module current (1324) (e.g., measurement of the module current) from the reference waveform signal (1320) (e.g., a measurement thereof).

Clause 6: The method of any of the preceding clauses, wherein the first gain component (1692) comprises a linear combination of digital integrators (1610, 1614).

Clause 7: The method of any of the preceding clauses, wherein said applying the transfer function comprises: applying, by the second gain component (1690), first order low pass filtering to the error signal (1328) to obtain a first filtered signal (1636); applying, by the first gain component (1692), a second order low pass filtering to the error signal (1328) to obtain a second filtered signal (1648); and combining the first and second filtered signals (1636, 1648) to obtain a third filtered signal (1649).

Clause 8: The method of any of the preceding clauses, wherein the error signal (1328) is additionally combined with the first and second filtered signals (1636, 1648) to obtain a third filtered signal (1649). The unit gain feature (1698), via which the error signal (1328) is combined to obtain the third filtered signal (1649), may or may not be a gain of one.

Clause 9: The method of any of the preceding clauses, wherein said applying the transfer function further comprises amplifying (1606) the error signal (1328) using the first low frequency DC gain value prior to applying the second order low pass filtering (1692) thereto and amplifying (1602) the error signal (1328) using the second low frequency DC gain value prior to applying the first order low pass filtering (1690) thereto.

Clause 10: The method of any of the preceding clauses, further comprising comparing the second filtered signal (1648) with a threshold value, and providing a result of said comparing to integrators (1610, 1614) of a second order low pass filter (1692).

Clause 11: The method of any of the preceding clauses, wherein said applying the transfer function further comprises: applying, by a third gain component (1694), first order low-shelving operations to the third filtered signal (1649) to obtain a fourth filtered signal (1654); combining the third and fourth filtered signals (1649, 1654) to obtain a fifth filtered signal (1656); and combining the error signal (1328) with the fifth filtered signal (1656) to obtain a combined signal (1658). It should be noted that there may be a gain different from one. The unit gain feature (1698), via which the error signal (1328) is combined to obtain the combined signal (1658), may or may not be a gain of one. The first order low-shelving operations may include, providing unity response (e.g., neither amplification nor attenuation) for high frequency components, amplification for low frequency components, and first order roll-off (e.g., −20 dB/decade) for intermediary frequency components.

Clause 12: The method of any of the preceding clauses, further comprising amplifying (1618) the third filtered signal (1649) prior to applying the first order low pass filtering thereto.

Clause 13: The method of any of the preceding clauses, further comprising: applying first order high-shelving operations (1950) to the combined signal (1658) to obtain a sixth filtered signal (1910); and combining (1908) the sixth filtered signal with the combined signal (1658). The first order high-shelving operations may include providing unity response (e.g., neither amplification nor attenuation) for low frequency components, a slope of +20 db/decade for intermediary frequency components, and amplification of high frequency components.

Clause 14: The method of any of the preceding clauses, further comprising: providing another reference waveform signal (520); acquiring an actual output voltage (534) of the energy storage module (100); generating another error signal (528) by combining the actual output voltage (524) with the another reference waveform signal (520); applying, to the another error signal (528), another transfer function to obtain another correction signal (530); generating another control signal (532) by combining the another correction signal (530) with the another reference waveform signal (520); and using the another control signal (532) to govern an output voltage of an inverter circuit (144) of the energy storage module (100).

Clause 15: The method of any of the preceding clauses, wherein at least one of the energy storage modules (100) comprises an inverter circuit.

Clause 16: The method of clause 15, wherein any one or more of the inverter circuits comprises an H-bridge circuit (e.g., an H-bridge inverter).

Clause 17: The method of any of the preceding clauses, comprising a use of any one or more of the equations herein disclosed to perform one or more methods (e.g., method steps).

Clause 18: An electrical system comprising means for performing the steps of any of the above method claims.

Clause 19: The electrical system of clause 18, preferably comprising at least one power converter.

Clause 20: The electrical system of clause 19, wherein at least one of the power converters is a buck type converter.

Clause 21: The electrical system of clause 16 or 17, wherein at least one of the power converters is an inverter, preferably a buck-type inverter.

Clause 22: The electrical system of any of clauses 19-21, wherein the at least one power converter (e.g., the H-bridge circuit) is the inverter circuit included in at least one of the energy storage modules (100).

Clause 23: A computer software product comprising instructions which when executed by a suitable electrical system (e.g., via one or more processors) cause the electrical system (e.g., any of the processors) to perform any of the herein disclosed methods (e.g., the steps of any of the above method clauses).

Clause 24: A circuit, comprising: an input port (306) at which an input voltage is provided; a pulse width modulator (1316) configured to provide a counter voltage; an inductor (420-1, 420-2) configured to convert a difference between the input voltage and the counter voltage to a module current (1324) which charges or discharges an energy storage module (100); a first combiner configured to generate an error signal (1328) by combining a measurement of the module current (1324) with a reference waveform signal (1320); a gain element configured to apply, to the error signal (1328), a transfer function to obtain a correction signal; and a second combiner configured to generate a control signal (1332) by combining the correction signal (1330) with a measurement of the input voltage (1370). The control signal (1332) is used to govern an instantaneous value of the module current (1324) to the energy storage module (100). The transfer function comprises: a first gain component (1692), wherein the first gain component (1692) has a higher than first-order low-pass response with a first low-frequency (e.g., DC) gain value; a second gain component (1690) acting parallelly to the first gain component (1692), wherein the second gain component (1690) has a second low-frequency (e.g., DC) gain value; and a unit gain response (1698) providing a gain between an input and output of the transfer function. The first low-frequency (e.g., DC) gain value is higher than the second low-frequency (e.g., DC) gain value.

Clause 25: The circuit according to Clause 24, further comprising an anti-aliasing filter configured to apply anti-aliasing filtering to the module current (1324) prior to generation of the error signal (1328).

Clause 26: The circuit according to any of the preceding circuit clauses, wherein the error signal (1328) is generated by subtracting the module current (1324) from the reference waveform signal (1320).

Clause 27: The circuit according to any of the preceding circuit clauses, wherein the first gain component (1692) comprises a linear combination of digital integrators (1610, 1614).

The breadth and scope of this disclosure should not be limited by any of the above-described example embodiments, but should be defined only in accordance with the following claims and their equivalents.

1. A method of operating a circuit with an energy storage module, the method comprising:
providing, at an input port, an input voltage;
providing, via a pulse width modulator, a counter voltage;
converting, via an inductor, a difference between the input voltage and the counter voltage to a module current which charges or discharges the energy storage module;
providing a reference waveform signal;
generating an error signal by combining a measurement of the module current with the reference waveform signal;
applying, to the error signal, a transfer function to obtain a correction signal;
generating a control signal by combining the correction signal with a measurement of the input voltage; and
using the control signal to govern an instantaneous value of the module current to the energy storage module,
wherein the transfer function comprises:
a first gain component, wherein the first gain component has a higher than first-order low-pass response with a first low-frequency gain value;
a second gain component acting parallelly to the first gain component, wherein the second gain component has a second low-frequency gain value; and
a unit gain response providing a gain between an input and output of the transfer function;
wherein the first low-frequency gain value is higher than the second low-frequency gain value.

2. The method according to claim 1, wherein the higher than first-order low-pass response has a first corner frequency and second gain component has a low-pass response with a second corner frequency higher than the first corner frequency.

3. The method according to claim 1, wherein the first low-frequency gain value is higher than the second low-frequency gain value, and the unit gain is lower than the second low-frequency gain value.

4. The method according to claim 1, further comprising applying anti-aliasing filtering to the module current prior to generating the error signal.

5. The method according to claim 1, wherein the first gain component comprises a linear combination of digital integrators.

6. The method according to claim 1, wherein said applying the transfer function comprises:
applying, by the second gain component, first order low pass filtering to the error signal to obtain a first filtered signal;
applying, by the first gain component, a second order low pass filtering to the error signal to obtain a second filtered signal; and
combining the first and second filtered signals to obtain a third filtered signal.

7. The method according to claim 6, wherein the error signal is additionally combined with the first and second filtered signals to obtain a third filtered signal.

8. The method according to claim 6, wherein said applying the transfer function further comprises amplifying the error signal using the first low frequency DC gain value prior to applying the second order low pass filtering thereto and amplifying the error signal using the second low frequency DC gain value prior to applying the first order low pass filtering thereto.

9. The method according to claim 6, further comprising comparing the second filtered signal with a threshold value, and providing a result of said comparing to integrators of a second order low pass filter.

10. The method according to claim 6, wherein said applying the transfer function further comprises:
applying, by a third gain component, first order low-shelving operations to the third filtered signal to obtain a fourth filtered signal;
combining the third and fourth filtered signals to obtain a fifth filtered signal; and
combining the error signal with the fifth filtered signal to obtain a combined signal.

11. The method according to claim 9, further comprising amplifying the third filtered signal prior to applying the first order low pass filtering thereto.

12. The method according to claim 9, further comprising:
applying first order high-shelving operations to the combined signal to obtain a sixth filtered signal; and
combining the sixth filtered signal with the combined signal.

13. The method according to claim 1, further comprising:
providing another reference waveform signal;
acquiring an actual output voltage of the energy storage module;
generating another error signal by combining the actual output voltage with the another reference waveform signal;
applying, to the another error signal, another transfer function to obtain another correction signal;
generating another control signal by combining the another correction signal with the another reference waveform signal; and
using the another control signal to govern an output voltage of an inverter circuit of the energy storage module.

14. An electrical system comprising means for performing the steps of the method of claim 1.

15. A computer software product comprising instructions which when executed by one or more processors of a suitable electrical system cause any of the processors to perform the steps of the method of claim 1.
